(19) United States
(12) Patent Application Publication
(10) Pub. No.: US 2025/0170909 A1
(43) Pub. Date: May 29, 2025

(54) SEGMENTED WIRELESS CHARGING SYSTEM FOR ELECTRIC VEHICLES UTILIZING PARALLEL CABLES

(71) Applicant: Optasia IP, LLC, Waco, TX (US)

(72) Inventors: Buford Randall Jean, Lorena, TX (US); John Edwin Ross, III, Moab, UT (US); James Daniel Lilly, Columbia, MD (US); James M. Salvitti, JR., Fort Worth, TX (US); Philip V. Pesavento, Waxahachie, TX (US); David Alexander Brighton, Cedar Hill, TX (US); Greg Allen Plant, Blooming Grove, TX (US); William C. McDaniel, Thornton, TX (US); Blake Alan Birmingham, Waco, TX (US)

(73) Assignee: Optasia IP, LLC, Waco, TX (US)

(21) Appl. No.: 18/521,500

(22) Filed: Nov. 28, 2023

(51) Int. Cl. B60L 53/122; H02J 50/10; H02J 50/20; H02J 50/40; H02J 50/90

(52) U.S. Cl. CPC B60L 53/122; H02J 50/10; H02J 50/20; H02J 50/40; H02J 50/90

(57) ABSTRACT

A parallel transmission line system is embedded in, laid atop, or suspended above a roadway to provide a mobile charging system for vehicles, including electric vehicles and drones. The parallel cable transmission line system includes a plurality of parallel line segments able to be individually modified with respect to amount of power supplied to each segment. The parallel transmission line system is configured to deliver power to many cars for a given line segment, which consequently results in reduced power per car. Because of this, the parallel transmission line system is able to operate independently of communications with the vehicles themselves, though the system is able to be optionally integrated with a V2X communication system.

### BACKGROUND OF THE INVENTION

### 1. Field of the Invention

The present invention relates to road-based wireless charging systems for electric vehicles, and more specifically to wireless charging systems utilizing parallel cable transmission lines.

### 2. Description of the Prior Art

It is generally known in the prior art to provide systems for electric vehicle charging, most commonly systems with plugs mimicking the manner in which traditional, gasoline-based cars refuel at a gas station. However, road-based wireless charging methods for electric vehicles have also been proposed by companies such as ELECTREON.

### Prior Art Patent Documents Include the Following:

U.S. Pat. No. 10,476,303 for Power supply and pickup system capable of maintaining stability of transmission efficiency despite changes in resonant frequency by inventors Cho et al., filed Jan. 15, 2019 and issued Nov. 12, 2019, discloses a power supply and pickup system capable of maintaining stability of transmission efficiency despite changes in a resonant frequency. More particularly, the present invention relates to a power supply and pickup system capable of maintaining the stability of efficiency of transmitting power to a pickup device from a power supply device even when a voltage or current changes by the variation in a resonant frequency. According to the power supply and pickup system of the present invention, Q-factor of a power supply and pickup system is set to a low value, a stability of efficiency of transmitting power to a pickup device from a power supply device is maintained even when a voltage of current changes by the variation in a resonant frequency.

U.S. Pat. No. 11,318,845 for System and method for powering on-road electric vehicles via wireless power transfer by inventor Rumbak, filed Oct. 17, 2019 and issued May 3, 2022, discloses a system for wireless power transfer of on-road vehicles. The system includes a plurality of base stations; a power transmission line located beneath a surface of a road having a plurality of segments, each segment having at least one pair of coils and at least one capacitor electrically connected via a switch to the coils in the segment; and at least one vehicle having at least one power receiving segment having at least two coils, connected to at least one capacitor, wherein the at least one vehicle further includes a communication transmitter configured to transmit a power requesting signal, wherein the coils of the power transmitting segment are configured to receive the power requesting signal; and wherein each of the base stations is further configured to feed a plurality of the power transmitting segments with current at a resonance frequency, responsive to the power requesting signal.

US Patent Pub. No. 2023/008378 for Wireless power transfer system, power transmission device, and power reception device by inventors Fujimoto et al., filed Sep. 10, 2020 and published Mar. 23, 2023, discloses a wireless power transfer system includes a power transmission device and a power reception device. The power transmission device is a power transmission device installed in a road, is provided with a power transmission coil that transmits power wirelessly, and is configured such that when installed in the road, the normal line of a coil plane of the power transmission coil is inclined with respect to the normal line of the road surface of the road in a lateral cross section of the road. The power reception device is provided with a power reception coil that receives power wirelessly, and at least a portion of the power reception coil is housed in the wheel of the moving body.

US Patent Pub. No. 2022/0032778 for In-motion power supply system, and abnormality determination method for electrical characteristics in said system by inventors Kanesaki et al., filed Oct. 19, 2021 and published Feb. 3, 2022, discloses, in an in-motion power supply system with a plurality of power supply segments to supply power to a vehicle, a vehicle position detection unit detecting a position of the vehicle relative to each segment. An electrical characteristic acquisition unit acquires electrical characteristics in the segment involved in power transfer, and an abnormality determination unit uses the electrical characteristics to determine whether there is an abnormality in the segment involved in power transfer. The abnormality determination unit shares the electrical characteristics between a subject segment subjected to abnormality determination and at least one of a previous segment previous to the subject segment and a subsequent segment subsequent to the subject segment, and compares the electrical characteristics in the subject segment with at least either the electrical characteristics in the previous segment or the electrical characteristics in the subsequent segment to determine whether the electrical characteristics in the subject segment are abnormal.

U.S. Pat. No. 10,790,692 for Mobile electric vehicle wireless charging by inventors Ahmed et al., filed Oct. 9, 2017 and issued Sep. 29, 2020, discloses a wireless vehicle charging system including a first cluster of charging pads wired to one another and configured to convert electrical energy to an electromagnetic field. The system further includes a first base station in communication with the first cluster of charging pads. The first base station is programmed to receive information from an electric vehicle and transmit the information to a second base station in communication with a second cluster of charging pads in a path of the electric vehicle.

U.S. Pat. No. 9,067,497 for Power transmitting device and power transfer system by inventors Ichikawa et al., filed Nov. 7, 2013 and issued Jun. 30, 2015, discloses a power transmitting device that contactlessly transmits electric power to a power receiving device having a secondary coil provided at a vehicle, and a power transfer system. The power transmitting device includes primary coils, a selecting unit and a control unit. The primary coils are arranged at an interval in an arrangement direction. The selecting unit selects one primary coil to which electric power is supplied from a power supply. The control unit controls the selecting unit by supplying the selected primary coil with a second electric power smaller than a first electric power, selecting a power transmitting coil from among the primary coils on the basis of at least one of a power transmitting situation of the selected primary coil and a power receiving situation of the secondary coil, and supplying the power transmitting coil with the first electric power.

US Patent Pub. No. 2022/0001753 for System for power feeding during traveling by inventors Takahashi et al., filed Sep. 15, 2021 and published Jan. 6, 2022, discloses a system for power feeding during traveling including a coil for power transmission, a power supply unit which supplies power to the coils, at least one shielding member which shields an electromagnetic field of the coil, and a hole provided to the shielding members.

US Patent Pub. No. 2020/0122601 for Vehicle charging lanes by inventor Nelson, filed Dec. 12, 2019 and published Apr. 23, 2020, discloses embodiments including an apparatus and methods for implementing lane charging for a roadway. A road segment in a geographic region is identified from a geographic database. The road segment may be identified based on the geographic position of a vehicle. A lane charging management device receives real time data related to the vehicle, the environment, or the electricity associated with the charging station. A lane charging command for a charging device associated with the road segment is generated in response to the real time data.

U.S. Pat. No. 10,857,893 for Ground-side power supply device by inventor Niizuma, filed Feb. 26, 2018 and issued Dec. 8, 2020, discloses a ground-side power feeding device including a ground-side power feeding coil that wirelessly transmits or receives power to or from a vehicle-side power feeding coil mounted in the vehicle via a magnetic field having a first frequency, a light emitting unit that is disposed at any position at least around the ground-side power feeding coil and in an upper portion of the ground-side power feeding coil when the ground-side power feeding coil is seen from above, and a light emitting power transmitting coil that wirelessly transmits power to the light emitting unit. The light emitting unit has a light emitting power receiving coil which wirelessly receives power from the light emitting power transmitting coil via a magnetic field having a second frequency different from the first frequency, and a light emitting body which emits light with power received by the light emitting power receiving coil.

U.S. Pat. No. 11,225,154 for Method for controlling power transmitting device in wireless power transmission system and power transmitting device by inventors Matsuo et al., filed Jan. 19, 2021 and issued Jan. 18, 2022, discloses a device including a power transmitting coil that outputs power to a power receiving coil included in a mobile object, a case that includes the power transmitting coil inside thereof, a mobile member arranged on the case at a position overlapping the power transmitting coil, and a circuit that controls the power transmitting coil and the mobile member. The circuit starts to perform an operation to move the mobile member from a position overlapping the power transmitting coil to a position not overlapping the power transmitting coil before the power transmitting coil and the power receiving coil are aligned with each other, and causes the power transmitting coil to output the power to the power receiving coil.

US Patent Pub. No. 2011/0184842 for Energy transfer systems and methods for mobile vehicles by inventor Melen, filed Jan. 28, 2010 and published Jul. 28, 2011, discloses an energy transfer system comprising a transmitter array, an energy transfer controller, a receiver array, and a charging module. The transmitter array is embedded in a roadway and the energy transfer controller is coupled to the transmitter array. The receiver array and the charging module are part of a mobile vehicle. The transmitter array and the receiver array each include a plurality of coils. The energy transfer controller estimates a likely trajectory of the mobile vehicle and energizes individual coils of the transmitter array using this position estimate. The energy transfer controller varies the resonant circuit component values of the transmitter during the transfer cycle such as resonant coupling capacitance values. The charging module also varies the resonant circuit component values of the coils in the receiver array to match the transfer array for transfer of energy from the transmitter array to the receiver array. The present invention also includes a method for energy transfer.

US Patent Pub. No. 2022/0072965 for Moving-object power supply system by inventors Mazaki et al., filed Nov. 17, 2021 and published Mar. 10, 2022, discloses, in a moving-object power supply system, a control unit selecting, as a power transmission segment, one of segments included in at least one power transmission section. The control unit supplies, through a power supply circuit, power to the power transmission segment to thereby generate a magnetic field through a power transmission coil of the power transmission segment. The control unit determines, based on an ascertained first electrical characteristic of the power transmission segment and an ascertained second electrical characteristic of at least one power non-transmission segment, whether there is a malfunction in each of the power transmission segment and the at least one power non-transmission segment.

US Patent Pub. No. 2022/0149663 for Power feeding system during travelling by inventors Sumiya et al., filed Jan. 20, 2022 and published May 12, 2022, discloses, in a dynamic wireless power transfer system, a power transmission coil provided in a road. A power transmission circuit supplies electric power to the power transmission coil. A power reception coil is provided in a vehicle. A power reception circuit is connected to the power reception coil. A relay circuit is provided in a tire of the vehicle. The relay circuit includes at least two relay coils that are connected in series. The relay circuit transfers electric power from the power transmission coil to the power reception coil by one relay coil of the two relay coils opposing the power transmission coil and the other relay coil opposing the power reception coil. A resonance frequency of the relay circuit is a frequency that is within a fixed range that is centered on an applied frequency of an alternating-current voltage that is applied to the power transmission coil.

### SUMMARY OF THE INVENTION

The present invention relates to road-based wireless charging systems for electric vehicles, and more specifically to wireless charging systems utilizing parallel cable transmission lines.

It is an object of this invention to provide a stable, sufficient mobile electric vehicle charging system to allow for longer sustained trips without the need to refuel.

In one embodiment, the present invention is directed to a mobile charging system for electric vehicles, including at least one cable loop embedded within or placed atop at least one roadway, at least one power supply line configured to provide current from at least one power source to the at least one cable loop, at least one controller configured to modulate an amount of power supplied to the at least one cable loop via the at least one power supply line, and at least one sensor configured to produce sensor data corresponding to an electromagnetic environment around the at least one cable loop and/or an electric property of the at least one cable loop, wherein at least one section of the at least one cable loop is oriented substantially parallel with the direction of traffic of the at least one roadway, and wherein the at least one controller increases or decreases the amount of power supplied to the at least one cable loop via the at least one power supply line based on the sensor data.

In another embodiment, the present invention is directed to a mobile charging system for electric vehicles, including at least one cable loop embedded within or placed atop at least one roadway, at least one power supply line configured to provide current from at least one power source to the at least one cable loop, at least one controller configured to modulate an amount of power supplied to the at least one cable loop via the at least one power supply line, and at least one sensor configured to produce sensor data corresponding to an electromagnetic environment around the at least one cable loop and/or an electric property of the at least one cable loop, wherein at least one section of the at least one cable loop is oriented substantially parallel with the direction of traffic of the at least one roadway, and wherein the at least one controller is operable to determine a number of electric vehicles on one or more of the at least one cable loop based on the sensor data.

In yet another embodiment, the present invention is directed to a mobile charging system for electric vehicles, including a plurality of sets of concentric cable loops, each including a first cable loop and a second cable loop, embedded within or placed atop at least one roadway, at least one power supply line configured to provide current from at least one power source to the at least one set of concentric cable loops, at least one controller configured to modulate an amount of power supplied to the at least one set of concentric cable loops via at least one power supply line, and wherein first sections of the first cable loop and the second cable loop of at least one of the plurality of sets of concentric cable loops are substantially parallel and separated by a first gap in or on a first roadway and wherein second sections of the first cable loop and the second cable loop of the at least one of the plurality of sets of concentric cable loops are substantially parallel and separated by a second gap in or on a second roadway, and wherein the at least one controller is configured to selectively couple two or more of the plurality of sets of concentric cable loops.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a top orthogonal view of an electric vehicle driving on a road including a parallel cable transmission line charging system according to one embodiment of the present invention.

FIG. 2 illustrates a front orthogonal view of a roadway including above-surface parallel cables in a parallel cable transmission line charging system according to one embodiment of the present invention.

FIG. 3 illustrates a front orthogonal view of a roadway including subterranean parallel cables in a parallel cable transmission line charging system according to one embodiment of the present invention.

FIG. 4 illustrates a front orthogonal view of a roadway include parallel cables approximately flush with the ground surface in a parallel cable transmission line charging system according to one embodiment of the present invention.

FIG. 5A illustrates individual parallel cable transmission lines installed in each lane of a two-way road according to one embodiment of the present invention.

FIG. 5B illustrates a two way roadway including concentric cable loops extending across lanes traveling in both directions to form transmission lines in multiple lanes according to one embodiment of the present invention.

FIG. 6 illustrates an extended network of concentric cable loops forming transmission lines for a larger electric vehicle charging system according to one embodiment of the present invention.

FIG. 7 illustrates a mobile charging system with node velocity matching vehicle velocity according to one embodiment of the present invention.

FIG. 8 illustrates a conceptual diagram for a mobile charging system according to one embodiment of the present invention.

FIG. 9 illustrates a mobile charging system with node velocity faster than vehicle velocity according to one embodiment of the present invention.

FIG. 10 illustrates a mobile charging system with node velocity faster than vehicle velocity according to one embodiment of the present invention.

FIG. 11 illustrates a mobile charging system with multiple loop segments according to one embodiment of the present invention.

FIG. 12 illustrates a mobile charging system with an on-vehicle RF generator according to one embodiment of the present invention.

FIG. 13 illustrates a cross-sectional diagram of a mobile charging system with an on-vehicle RF generator with a single cable according to one embodiment of the present invention.

FIG. 14 illustrates a cross-sectional diagram of a mobile charging system with an on-vehicle RF generator with two parallel cables according to one embodiment of the present invention.

FIG. 15 illustrates a conceptual diagram of components of a mobile charging system with an on-vehicle RF generator according to one embodiment of the present invention.

FIG. 16A illustrates the state of a mobile charging system reliant on on-vehicle RF generators with a vehicle present according to one embodiment of the present invention.

FIG. 16B illustrates the state of a mobile charging system reliant on on-vehicle RF generators without a vehicle present according to one embodiment of the present invention.

FIG. 17 illustrates a network architecture for a parallel cable transmission line for wireless power transfer to an electric vehicle according to one embodiment of the present invention.

FIG. 18A is a schematic diagram of actual and simulated parallel cable transmission lines providing wireless power transfer to a receiver antenna of a moving electric vehicle according to one embodiment of the present invention.

FIG. 18B is a cross-sectional diagram of the parallel cable transmission line system shown in FIG. 18A taken along section AA.

FIG. 19 is a schematic diagram of actual and simulated parallel cable transmission lines providing wireless power transfer to a receiver antenna of a stationary electric vehicle according to one embodiment of the present invention.

FIG. 20 is a block diagram showing exchange of data information between a vehicle-to-everything (V2X) server and other V2X components in a V2X communication environment according to one embodiment of the present invention.

FIG. 21 is a block diagram showing various components of a V2X server according to one embodiment of the present invention.

FIG. 22 is a flow diagram of a process for implementing wireless power transfer to an electric vehicle according to one embodiment of the present invention.

FIG. 23 is a flow diagram of a process for adjusting the configuration of a receiver antenna of an electric vehicle according to one embodiment of the present invention.

FIG. 24 is a schematic diagram of a system of the present invention.

### DETAILED DESCRIPTION

The present invention is generally directed to road-based wireless charging systems for electric vehicles, and more specifically to wireless charging systems utilizing parallel cable transmission lines.

In one embodiment, the present invention is directed to a mobile charging system for electric vehicles, including at least one cable loop embedded within or placed atop at least one roadway, at least one power supply line configured to provide current from at least one power source to the at least one cable loop, at least one controller configured to modulate an amount of power supplied to the at least one cable loop via the at least one power supply line, and at least one sensor configured to produce sensor data corresponding to an electromagnetic environment around the at least one cable loop and/or an electric property of the at least one cable loop, wherein at least one section of the at least one cable loop is oriented substantially parallel with the direction of traffic of the at least one roadway, and wherein the at least one controller increases or decreases the amount of power supplied to the at least one cable loop via the at least one power supply line based on the sensor data.

In another embodiment, the present invention is directed to a mobile charging system for electric vehicles, including at least one cable loop embedded within or placed atop at least one roadway, at least one power supply line configured to provide current from at least one power source to the at least one cable loop, at least one controller configured to modulate an amount of power supplied to the at least one cable loop via the at least one power supply line, and at least one sensor configured to produce sensor data corresponding to an electromagnetic environment around the at least one cable loop and/or an electric property of the at least one cable loop, wherein at least one section of the at least one cable loop is oriented substantially parallel with the direction of traffic of the at least one roadway, and wherein the at least one controller is operable to determine a number of electric vehicles on one or more of the at least one cable loop based on the sensor data.

In yet another embodiment, the present invention is directed to a mobile charging system for electric vehicles, including a plurality of sets of concentric cable loops, each including a first cable loop and a second cable loop, embedded within or placed atop at least one roadway, at least one power supply line configured to provide current from at least one power source to the at least one set of concentric cable loops, at least one controller configured to modulate an amount of power supplied to the at least one set of concentric cable loops via at least one power supply line, and wherein first sections of the first cable loop and the second cable loop of at least one of the plurality of sets of concentric cable loops are substantially parallel and separated by a first gap in or on a first roadway and wherein second sections of the first cable loop and the second cable loop of the at least one of the plurality of sets of concentric cable loops are substantially parallel and separated by a second gap in or on a second roadway, and wherein the at least one controller is configured to selectively couple two or more of the plurality of sets of concentric cable loops.

As global economies shift to focus on reducing carbon emissions by incentivizing sale of electric, rather than gasoline-based, vehicles, one issue for increased adoption is charging. Currently, charging is done while a vehicle is stationary, typically at the home or at gas stations where the user must wait at least 15 minutes, if not much longer, in order for the vehicle to finish charging. This has raised concern among avid drivers, who are accustomed to being able to immediately refuel their vehicles. This issue of charging time, coupled with a still relatively sparse number of chargers and skepticism about overall battery capacity has slowed adoption of the new technology. One way to address this issue is develop charging networks that work for mobile vehicles, to extend battery life or even obviate much of the need for stationary chargers.

One company that has attempted to address mobile charging is ELECTREON, whose technology is described in such patents as U.S. Pat. No. 11,318,845. ELECTREON's technology focuses on a wireless charging system with embedded electrical coils buried roughly in the center of a roadway. These coils are configured to wirelessly charge receiver coils on the bottom of electric vehicles when the receiver coils are above the embedded electrical coils. However, this system has important limitations. Notably, the set-up of ELECTREON's system requires the receiver coils to be almost directly above the embedded electrical coils. This means that, ironically, the system works more optimally in congested city environments where vehicles are frequently stopped and stationary over the embedded coils, rather than constantly moving. Furthermore, ELECTREON's system appears to require a very large number of coils to be embedded, almost requiring a complete overhaul of roadway systems in order to install the coils underneath the roadway. Thus, in terms of both cost and materials, the embedded coil-based system suffers issues in terms of efficiency of cost, time, and materials. In countries without strong central management initiatives, large scale and comprehensive installation of the system is unlikely to be feasible. Therefore, a more scalable, easier to install system and a system focused on long distance (e.g., highway) charging is needed.

The use of parallel cables to form transmission lines, instead of embedded pads, represents an alternative paradigm for electric vehicle charging.

Referring now to the drawings in general, the illustrations are for the purpose of describing one or more preferred embodiments of the invention and are not intended to limit the invention thereto.

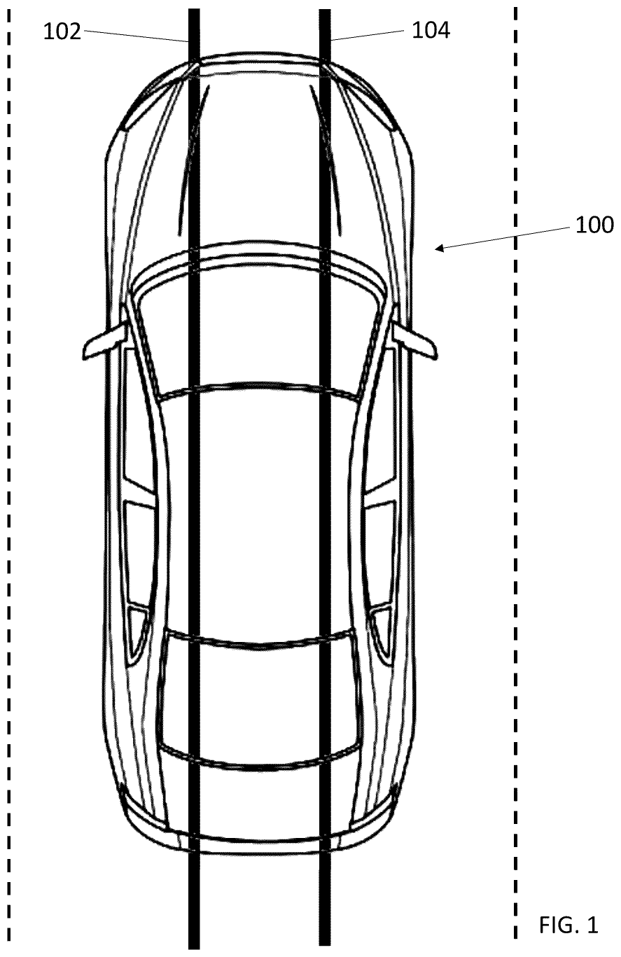

FIG. 1 illustrates a top orthogonal view of an electric vehicle driving on a road including a parallel cable transmission line charging system according to one embodiment of the present invention. In one embodiment, the parallel cable transmission line charging system includes a first cable 102 substantially parallel to a second cable 104, wherein the combination of the first cable 102 and the second cable 104 constitute a transmission line. As shown in FIG. 1, the cables 102, 104 are positioned such that they are on opposite sides of a midline of a vehicle lane. In one embodiment, the cables 102, 104 are equidistant from a midline of the vehicle lane. For example, in one embodiment, the cables 102, 104 are positioned are approximately 30% and 70% of the thickness of the lane, respectively, although any position (e.g., 15/85, 10/90, 20/80, 25/75, 35/65, 60/40, etc.) is acceptable. In one embodiment, the cables 102, 104 are configured such that they are both positioned between the tires of the electric vehicle 10 when the electric vehicle 10 is directly in the center of the lane. In a preferred embodiment, the cables 102, 104 are positioned (and therefore the transmission line is positioned) such that they are still between the tires of the electric vehicle 10 even if the electric vehicle 10 moves slightly out of the center of the lane. In an alternative embodiment, the cables 102, 104 are positioned such that they are outside of the wheels of the electric vehicle 10 when the electric vehicle 10 is directly in the center of the lane.

The transmission line is configured to wirelessly interact with a receiver antenna on at least one electric vehicle 10. In one embodiment, the receiver antenna includes a half-wave dipole antenna including one or more radiation lobes for non-ohmic coupling with the transmission line. In one embodiment, the radiation lobes include radiation patterns perpendicular to a conductor of the receiver antenna. The receiver antenna is able to receive wireless power transfer in order to charge one or more batteries of the electric vehicle 10.

The output (i.e., Thévenin) voltage from a parallel cable transmission line with a single receiver coil is provided by Equation 1 below, while the voltage in the phasor domain for each turn of the receiver coil is provided in Equation 2, and is proportional to the magnetic flux (ψ, Ψ′) (in Webers).

$$v ( t ) = N \frac{d ψ}{dt} \qquad ( Equation 1 )$$

$$V = N ( j ωΨ ) \qquad ( Equation 2 )$$

Assuming the magnetic field is approximately constant over the loop area, with H/2 equal to the distance (H being the total distance between the two cables) from the center of the loop to each parallel cable, with equal contribution from each cable, Equation 3 provides the magnetic flux in terms of current, length (L), and width (W) of the coil, allowing for a revised voltage calculation in Equation 4.

$$Ψ = 2 [ \frac{{μ}_{0} I}{2 π ( \frac{H}{2} )} LW ] \qquad ( Equation 3 )$$

$${V}_{T h} = 2 Nj ω [ \frac{{μ}_{0} I}{2 π ( \frac{H}{2} )} LW ] \qquad ( Equation 4 )$$

The magnitude of the Thevenin voltage is therefore determined by Equation 5, which is able to be inserted into an equation to determine the power loss of the wire, including a load resistance R_{L}, according to Equations 6 and 7 below.

$$\vert {V}_{T h} \vert = \frac{2 {μ}_{0}}{π} \vert I \vert N ω [ \frac{L W}{H} ] \qquad ( Equation 5 )$$

$${P}_{L} = \frac{1}{2} {\vert {V}_{T h} \vert}^{2} [ \frac{{R}_{L}}{{( {R}_{c} + {R}_{L} )}^{2}} ] \qquad ( Equation 6 )$$

$${P}_{L} = 2 {\vert I \vert}^{2} {\vert \frac{{μ}_{0}}{π} ( \frac{L W}{H} ) \vert}^{2} [ \frac{{R}_{L}}{{( {R}_{c} + {R}_{L} )}^{2}} ] {( N ω )}^{2} \qquad ( Equation 7 )$$

The Thévenin resistance is able to be approximated as the coil resistance, calculated along a length, I, according to Equation 8, with Rₛ equal to the surface resistance of the receiver coil metal, a_{c} being the coil wire radius, and conductivity of the coil, σ_{c}, equal to

$$5.8 * 1 {0}^{7} \frac{S}{m} .$$

$${R}_{c} = \frac{{R}_{s} l}{2 π {a}_{c}} = \sqrt{\frac{ω {μ}_{0}}{2 {σ}_{c}}} ( \frac{l}{2 π {a}_{c}} ) \qquad ( Equation 8 )$$

Assuming that the length, l, is equal to 2N (L+W) and therefore that N=1/(2 (L+W)), Nis able to be set according to Equation 9, where p is a chosen value (e.g., 0.05) that constrains the total length of the coil wire l to pλ₀, allowing for a simplification of power to be calculated according to Equation 10.

$$N = \frac{p {λ}_{0}}{2 ( L + W )} = \frac{p π c}{ω ( L + W )} \qquad ( Equation 9 )$$

$${P}_{L} = 2 {p}^{2} {η}^{2} {\vert I \vert}^{2} {\vert \frac{L W}{L + W} ( \frac{1}{H} ) \vert}^{2} ( \frac{{R}_{L}}{{( {R}_{c} + {R}_{L} )}^{2}} ) \qquad ( Equation 10 )$$

The efficiency, e_{c}, of the system is able to be determined according to Equation 11, where P_{c} is equal to the heat dissipation, not account for eddy current losses in the earth or vehicle chassis, or radiation losses, which will decrease the efficiency from this optimum value.

$${e}_{c} = \frac{{P}_{L}}{{P}_{L} + {P}_{c}} = \frac{{R}_{L}}{{R}_{c} + {R}_{L}} \qquad ( Equation 11 )$$

It will be noted from Equations 10 and 11 that the maximum power transfer occurs when R_{L}=R_{c}, but that the efficiency is only 50% at this point, indicating a tradeoff between maximizing power and maximizing efficiency, with the relationship being described by Equation 12.

$${R}_{L} = ( \frac{{e}_{c}}{1 - {e}_{c}} ) {R}_{c} \qquad ( Equation 12 )$$

Furthermore, given that the power dissipation along the highway cable, per meter, is described in Equation 13, the resistance per unit length, Rₕᵢ, of the cable is able to be calculated as according to Equation 14 (where the factor of 2 results from there being two cables).

$${P}_{c a b l e} = \frac{1}{2} {R}_{h l} {\vert I \vert}^{2} \qquad ( Equation 13 )$$

$${R}_{h l} = 2 ( \frac{{R}_{s}}{2 π {a}_{h}} ) = 2 \sqrt{\frac{ω {μ}_{0}}{2 {σ}_{h}}} ( \frac{1}{2 π {a}_{h}} ) \qquad ( Equation 14 )$$

These equations are then able to be generalized to multiple cables, where the number of cables is equal to Nₕ cables running in parallel on each side of the highway. Each cable therefore carries

$$\frac{I}{{N}_{h}}$$

amperes if the total current is I with the power dissipation in each cable being reduced by a factor of Nₕ² and because there are Nₕ cables, the total power dissipation is then reduced by Nₕ. Thus, again ignoring eddy current losses in the earth and car chassis, the efficiency is able to be calculated according to Equation 15, where P_{cable} is equal to the power dissipated in one meter of a single twin lead cable with N=1.

$${e}_{system} = \frac{M {P}_{L}}{M {P}_{L} + \frac{( 1000 ) {P}_{cable}}{{N}_{h}}} \qquad ( Equation 15 )$$

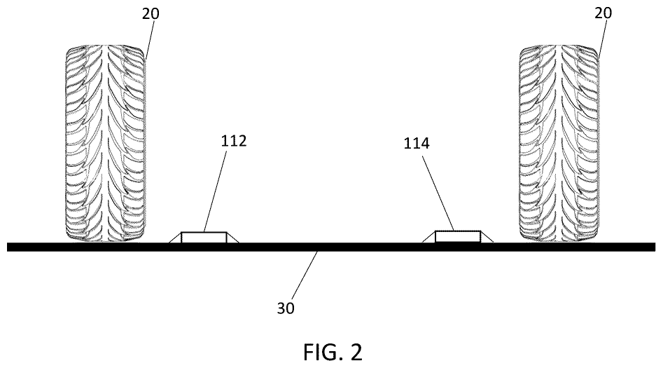

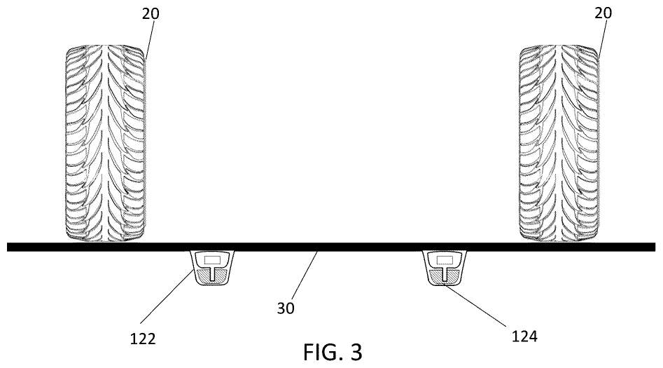

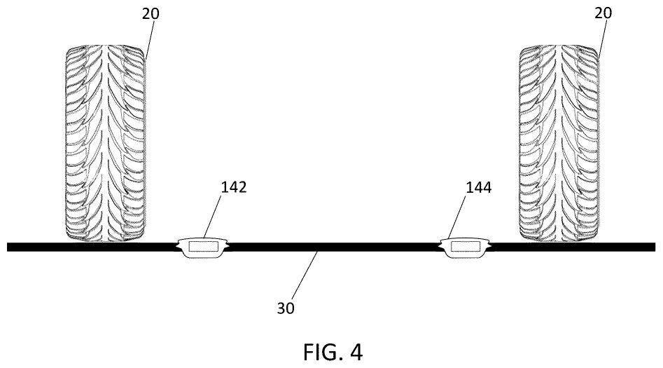

FIG. 2 illustrates a front orthogonal view of a roadway including above-surface parallel lines in a parallel cable transmission line charging system according to one embodiment of the present invention. In one embodiment, cables for the transmission line are laid on top of an existing roadway and covered with a relatively thin layer of topcoat for protection. As shown in FIG. 2, a first cable 112 and a second cable 114 are laid atop a road 30 and positioned such that they are between the wheels 20 of an electric vehicle (not shown). This method of deployment is advantageous as it allows the transmission line to be quickly laid, without needing to dig into the road and is able to be easily removed and replaced as needed. However, the challenges faced by this system are that the road will become slightly uneven, possibly being noticeable to drivers and that the above-ground exposure of the cables potentially leads to the cables being more easily damaged than in the two configurations discussed with reference to FIGS. 3 and 4.

FIG. 3 illustrates a front orthogonal view of a roadway including subterranean parallel cables in a parallel cable transmission line charging system according to one embodiment of the present invention. In one embodiment, cables for the transmission line are laid entirely subterranean to the roadway. In this embodiment, trenches are able to dug in the roadway and the cables placed within before covering up the trenches to form a smooth, or substantially smooth, road surface. In one embodiment, the cables include an anchor able to dug into subsurface concrete for stability. As shown in FIG. 3, a first cable 122 and a second cable 124 are laid beneath a road 30 and positioned such that they are between the wheels 20 of an electric vehicle (not shown). This method of deployment is advantageous, as it does not disturb the road surface and provides for a more permanent installation solution. Furthermore, this method is more likely to prevent damage to the cables, though it may make changing the cables and performing repairs more difficult. However, this installation is likely to cost more time and money than an above-ground solution.

FIG. 4 illustrates a front orthogonal view of a roadway include parallel cables approximately flush with the ground surface in a parallel cable transmission line charging system according to one embodiment of the present invention. In one embodiment, the cables are wrapped in an insulated shell (e.g., an insulated composite sleeve) that is placed within a shallow indentation in the roadway and fused with the roadway such that top surface of the insulated shell is substantially flush with the surface of the roadway. As shown in FIG. 4, a first cable 142 and a second cable 144 are laid within a road 30 and positioned such that they are between the wheels 20 of an electric vehicle (not shown). This method of deployment is advantageous, as it requires less deep (and thus likely thus expensive and time consuming) trenches to be dug for the insulated shell, as the entirely the shell does not need to be underground. It also allows for easier modification than the system shown in FIG. 3, as the insulated shell merely needs to be peeled back in order to repair or replace part of the cables of the transmission line, instead of needing to dig up asphalt. However, the risk of damaging the cables through the melting process is greater than in the systems shown in FIGS. 2 and 3. FIGS. 2-4 therefore provide a variety of methods to install the system of the present invention, suitable for different purposes, different budgets, and carrying different risks.

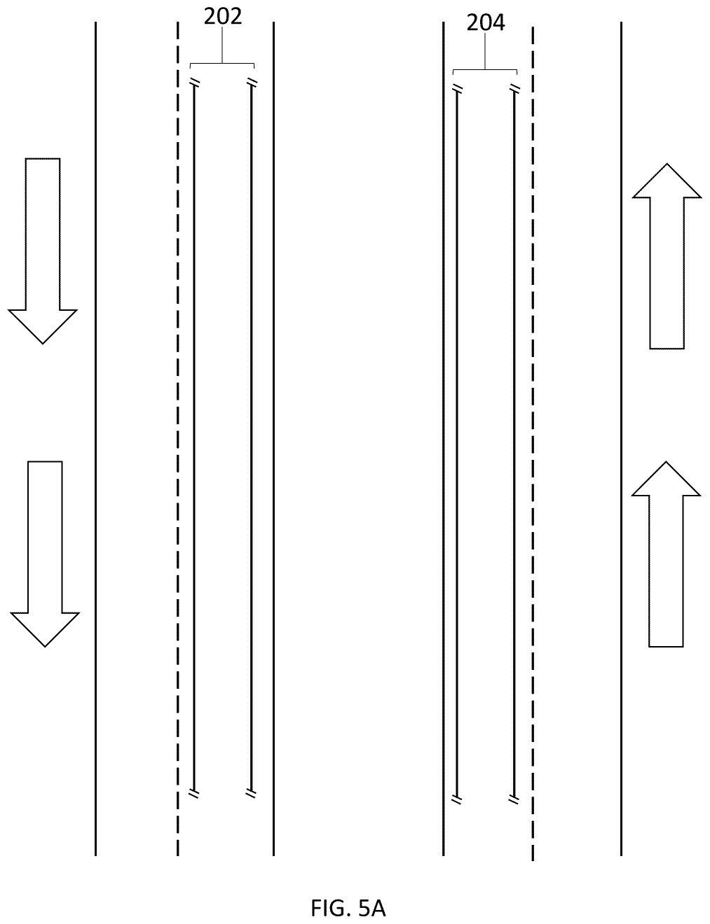

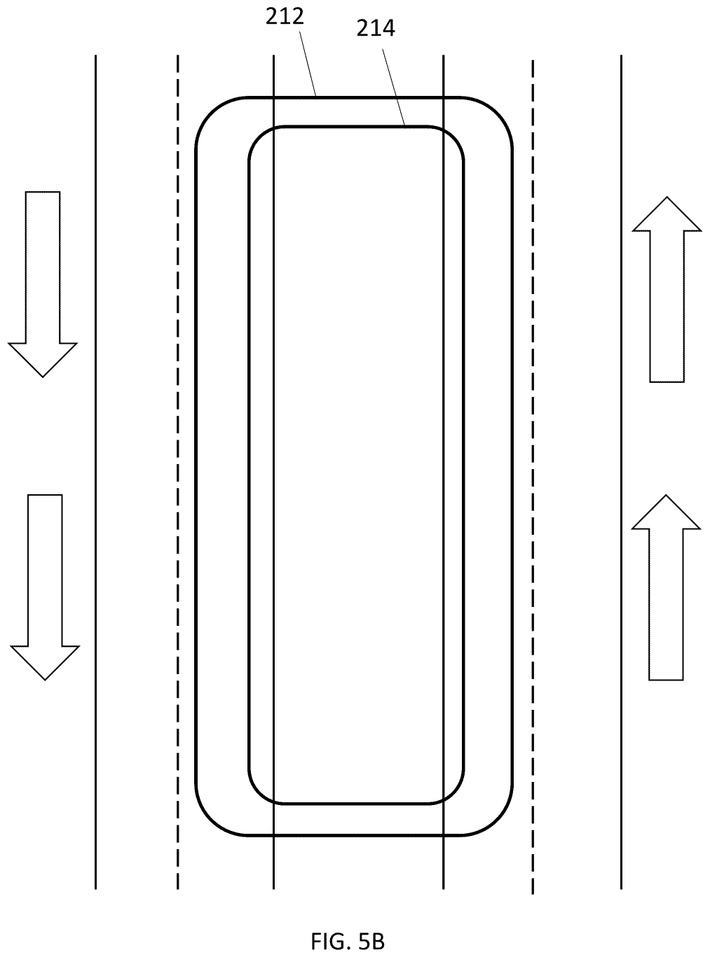

FIG. 5A illustrates individual parallel cable transmission lines installed in each lane of a two-way road according to one embodiment of the present invention. In one embodiment, each lane includes a self-contained transmission line, such that there is a parallel cable transmission line 202 in a lane moving in a first direction and separate parallel cable transmission line 204 in a lane moving in a second, opposite direction. This is the simplest and most straightforward method of installation and allows construction and installation to be performed in isolated chunks for ease of management. Furthermore, this system is compatible even in areas where, for example, the lanes in a first direction go over a bridge and the lanes in the southbound direction go over another, parallel bridge, such that there is a gap between the roads, or where there is very rough terrain between the lanes moving in a first direction and those moving in the opposite direction.

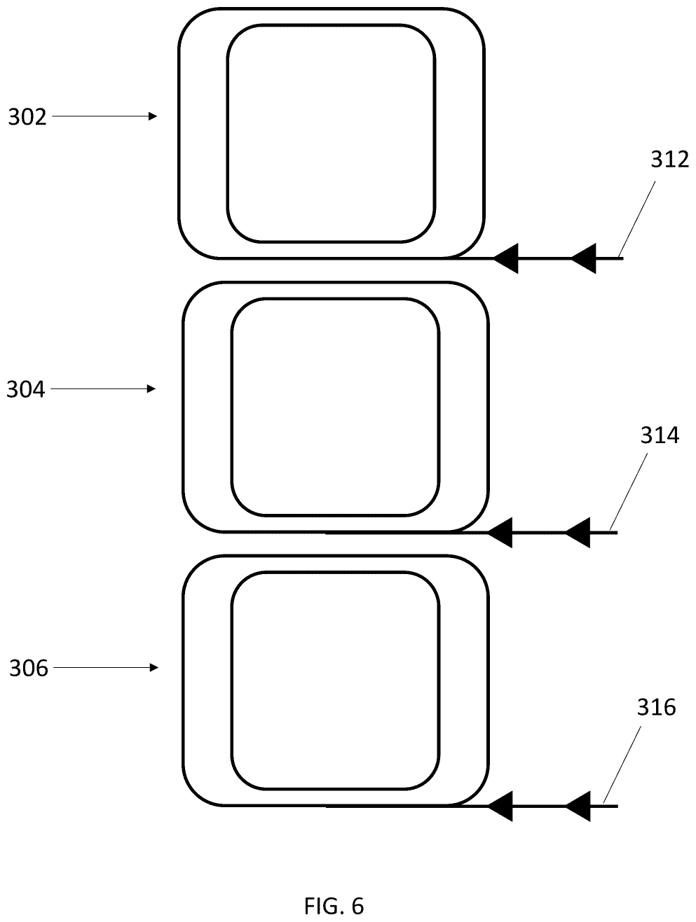

FIG. 5B illustrates a two way roadway including concentric cable loops extending across lanes traveling in both directions to form transmission lines in multiple lanes according to one embodiment of the present invention. In another embodiment, the parallel transmission line system includes a first cable loop 212 and a second cable loop 214 that are substantially concentric. For example, as shown in FIG. 5B, the first cable loop 212 is an outer loop that extends through an outer side of a first lane traveling in a first direction and through an outer side of a second lane traveling in a second, opposite direction. The second cable loop 214 is an inner loop that extends through an inner side of the first lane and through an inner side of the second lane. Therefore, the combination of the first cable loop 212 and the second cable loop 214 together form a first transmission line extending through the first lane and a second transmission line extending through the second lane. Having cable loop systems extend through lanes moving both directions allows for ease of coupling of multiple loop segments, as discussed with reference to FIG. 6 below. In one embodiment, the portions of each loop oriented substantially perpendicular to the direction of the flow of traffic and/or the portions of each loop not oriented substantially parallel to the direction of the flow of traffic are more heavily insulated, such that these portions of the loop that are not likely to contribute to charging of the vehicles do not have excessive power loss or emit too much excess RF radiation. Furthermore, one of ordinary skill in the art will understand that although the diagram in FIG. 5B shows a gap between the first cable loop 212 and the second cable loop 214 for the entire circumference of both cable loops, this does not necessarily need to be the case. In one embodiment, the portions of the first cable loop 212 and the second cable loop 214 that are oriented perpendicular to and/or are not oriented parallel to the flow of traffic are bundled together as to the save space, as the separation between the cable loops is not needed outside of areas where they are likely to charge the vehicles.

One of ordinary skill in the art will understand that other orientations of the loops are also possible. For example, concentric loops forming transmission lines in multiple lanes traveling in the same direction are also contemplated herein. One of ordinary skill in the art will understand that greater than two cables are able to be used for a single lane (i.e., greater than two parallel cables are able to be used to form the transmission lines). In fact, a preferred embodiment includes multiple cable loops, providing greater than two parallel cables in a single lane, increasing power transfer.

FIG. 6 illustrates an extended network of parallel cable loops forming segments of a larger electric vehicle charging system according to one embodiment of the present invention. In one embodiment, a broader power transmission system includes a plurality of transmission line segments 302, 304, 306 that are able to be individually controlled and powered. The configuration of the broader power transmission system having multiple independent cable loops allows for more finely tuned modifications to be made where load is increased on, for example, one loop segment but is relatively stable or even decreasing on another loop segment. Furthermore, the inclusion of multiple loop segments is advantageous in that damage to one part of one cable loop does not take the entire transmission line, but only renders a small portion of the system inoperable, providing an overall more stable system. In the diagram shown in FIG. 6, the power transmission system includes, at least, a first transmission line segment 302, a second transmission line segment 304, and a third transmission line segment 306. The first transmission line segment 302, the second transmission line segment 304, and the third transmission line segment 306 shown are positioned in series, such that a car driving along one transmission line segment 302 will subsequently drive over the second 304 and third transmission line segments 306. Current is transmitted to the first transmission line segment 302 via a first power supply line 312. Current is transmitted to the second transmission line segment 304 via a second power supply line 314. Current is transmitted to the third transmission line segment 306 via a third power supply line 316. In one embodiment, the first power supply line 312, the second power supply line 314, and/or the third power supply line 316 are able to draw power from the same one or more power sources or from different power sources. In one embodiment, each transmission line segment is between approximately 1 km and 100 km in length, with loops of varying length able to form part of a single system.

In one embodiment, adjacent transmission line segments are able to be selectively coupled in order to allow for power from one transmission line segment to transfer into another transmission line segment, allowing for a more dynamic power system. This is especially important where the amount of power able to be transferred to the transmission line segment via a corresponding power supply line from available, connected power sources is inadequate to meet demand, either due to increased demand or due to faults in the connected power sources. In one embodiment, the transmission line segments are able to directly coupled via switches in lines running between the separate segments. In this embodiment, one or more controllers are operable to selectively change the position of the switches and/or the rate of switching of the switches between the segments, in order to modulate the amount of power flow between segments. In another embodiment, in lieu of or in additional to direct coupling between the adjacent segments, the adjacent segments are inductively coupled in order to transfer energy between segments.

In one embodiment, each transmission line segment is configured to operate at a power of approximately 1 MW and controlled so as to maintain a relatively constant power level in the cables. Preferably, the wave form of power moving through the transmission line segment is also stably maintained.

In one embodiment, the transmission line system includes one or more sensors operable to detect an electromagnetic environment around the constituent cable loops of the system and/or the electrical parameters of the cable loops themselves. In one embodiment, the one or more sensors are embedded in the roadway, placed atop the roadway, and/or placed in proximity to the roadway as needed. One of ordinary skill in the art will understand that the specific number of sensors employed in the present invention is not intended to be limiting and is able to encompass any total number or any combination of numbers of sensors as is necessary to determine the intended electrical characteristics. For example, in one embodiment, the transmission line system includes one or more voltage sensors (e.g., Hall effect sensors, capacitive voltage dividers, resistive voltage dividers, electrostatic sensors, piezoelectric sensors, optical sensors, inductive sensors, etc.), magnetic field sensors (e.g., Hall sensors, superconducting quantum interference device (SQUID), fluxgate sensors, induction magnetometer, linear variable differential transformer, ferromagnetic magnetoresistors, etc.), electric field sensors (e.g., electric field mill, micro electro-mechanical system (MEMS) sensors, etc.), line frequency sensors, and/or current sensors (e.g., cored current sensors, coreless current sensors, shunt resistor+high speed amps, etc.). In one embodiment, one or more controllers and/or one or more distributed processors are operable to receive sensor data from the one or more sensors. In one embodiment, the one or more controllers and/or the one or more distributed processors are operable to automatically determine a number of vehicles drawing power from a particular segment of the transmission line system. In one embodiment, based on the determined number of vehicles on a particular segment, the controllers are operable to control and/or the one or more distributed processors are operable to a controller to control an amount of power supplied to the particular segments. It should be noted that this system does not require actual communication between the vehicles and any external processors or servers, and the actual identity of the individual vehicles is not required to be obtained in this method, but merely the number of cars, which is determined entirely based on the effects of the vehicles' presence on the electrical characteristics of the transmission line system itself.

In one embodiment, at least one local processor and/or at least one local controller is operable to receive power supply data from at least one power source connected to the transmission line segments via at least one power supply line. In one embodiment, the power supply data includes an amount of power currently to be supplied to a transmission line segment from the at least one power source and/or an amount of power predicted to be available to be supplied at one or more future times (e.g., in one minute, in five minutes, in one hour, etc.). In one embodiment, the at least one local processor and/or the at least one local controller is operable to transmit at least one external power supply request to at least one central (or higher level) controller and/or at least one central server requesting power from power sources other than the at least one power source connected to the segment. In one embodiment, the at least one central controller and/or the at least one central server is then able to communicate coupling commands to one or more other local processor and/or local controllers for coupling other segments (connected to other power sources with additional supply) to the requesting segment in order to provide additional power to the needed transmission line segment. In one embodiment, the at least one central controller and/or the at least one central server at first sends polling requests to one or more other local processors to determine which other local processors have sufficient supply in order to be provided to the requesting transmission line segment.

In a preferred embodiment, the transmission line system of the infrastructure and the receiver systems of each electric vehicle operate independently, such that there is not a requirement for cross-communication between the two systems. This is advantageous as it does not rely upon network communications that are potentially faulty, risks bias towards particular types of vehicles, and minimizes the number of factors that must be considered by a central system, thereby reducing complexity. Thus, in a preferred embodiment, the transmission line system does not receive any messages from an electric vehicle and/or from third-party sources indicating characteristics of specific electric vehicles utilizing the system, as the transmission line system operates independently of the operation of the electric vehicles themselves, except insofar as the transmission line system is able to be responsive to the total load on individual segments of the transmission line system.

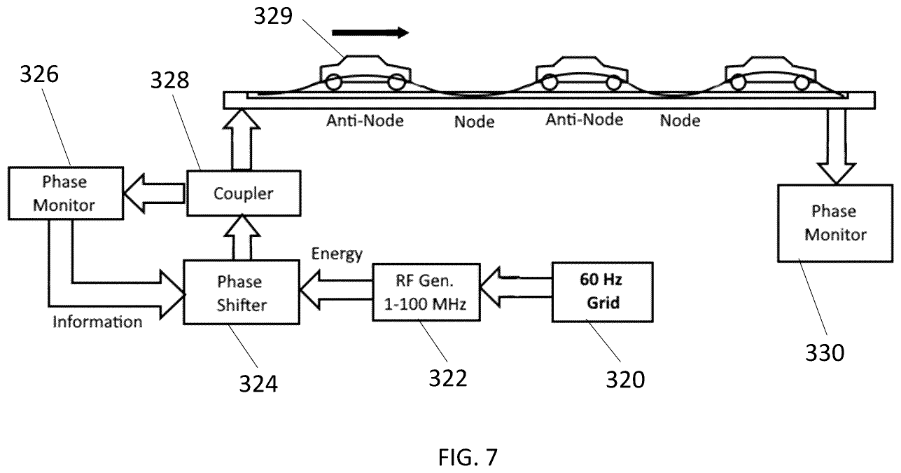

FIG. 7 illustrates a mobile charging system with node velocity matching vehicle velocity according to one embodiment of the present invention. A power grid source 320 supplies power to a mobile charging system. In one embodiment, the power grid source supplies alternating current, but, in another embodiment, the power grid source 320 supplies direct or alternating current. In one embodiment, the alternating current supplied by the power grid source 320 has a frequency of approximately 60 Hz. One of ordinary skill in the art will understand that the power grid source 320 is able to include a line connected to a central grid, to a local microgrid, and/or to one or more distributed energy resources (e.g., solar panels, geothermal generators, etc.).

The power grid source 320 is connected to at least one radiofrequency (RF) generators 322, which is operable to produce radiofrequency signals for use in the wireless charging. In one embodiment, the RF generator 322 generates RF signals having a frequency between about 1 MHz and about 100 MHz. The use of MHz frequencies for the present invention provides an important advantage over prior art systems, in that the high frequencies allows the signals to be received even by relatively inexpensive sheet metal materials based on electroconductive properties, rather than requiring ferrites or rare earth metals that greatly increase the cost of installation, especially at scale. This is because the MHz frequencies enable conductive metal sheets to exhibit strong inductive properties to provide strong coupling. The MHz frequencies enable the transmission line to have fast field fall off as well.

In one embodiment, the frequency generated by the RF generator 322 is set such that the wavelength of the signal is approximately equal to the average distance between vehicles 329 in the same lane. The importance of this frequency selection is related to the charging characteristics of the line and specifically to the fact that the generated RF signal acts as a standing wave moving along the transmission lines. The standing wave includes anti-nodes where the signal strength is at its highest, and therefore where charging will occur most efficiently, and nodes, where the signal strength is at its lowest (e.g., zero) and where charging will occur least efficiently. In one embodiment, the average distance between vehicles 329 for a particular stretch is determined based on a static quantity associated with the stretch (e.g., a speed limit) and/or based on one or more sensors (e.g., cameras, power sensors, etc.) operable to detect the total vehicles per unit area for a stretch. In one embodiment, the vehicles 329 include at least one sensor operable to detect the power level at a particular location and to then automatically speed up or slow down (e.g., via a self-driving mechanism, cruise control mechanism, etc.) to center on an anti-node and then to travel at approximately the same speed as the anti-node to maintain high charging, as traffic permits. In one embodiment, the antinodes of the standing wave move at approximately constant velocity, allowing for consistency in speed. This provides for a regulated and orderly way for each car along a section of road to maximize charging at all times. In this embodiment, the system need not be concerned without adjusting the standing wave to perfectly align with the vehicles, as this responsibility is shifted onto the vehicles themselves.

The RF signals are then able to be phase shifted by at least one phase shifter 324. The at least one phase shifter 324 is then connected to the parallel lines by at least one coupler 328, thereby allowing for the wireless charging. The at least one phase shifter 324 is able to allow the standing wave generated by the transmission line to move along the length of the transmission line, with the speed at which the standing wave moves also being able to be modified by the at least one phase shifter 324. In one embodiment, the at least one phase shifter 324 is connected to at least one phase monitor 326 operable to detect the phase in the line and/or in another adjacent loop. The at least one phase monitor 326 is thereby able to provide sensor data to the at least one phase shifter 324 that enables the at least one phase shifter 324 to phase match the signal already in the line and/or in an adjacent line, preventing potentially harmful errors. In one embodiment, the at least one phase shifter 324 is connected to multiple phase monitors 326, 330, connected to different sections of the line. In one embodiment, the at least one RF generator 322 receives sensor data from at least one power monitor, operable to detect the total power along a particular stretch and is operable to automatically increase or decrease the frequency of the generated RF signal based on the total power drop in order to match the likely speed and distance between cars. For example, if the stretch is very congested and therefore cars are more likely to be close to each other, the RF generator 322 is able to automatically increase the frequency, thereby decreasing the wavelength and ensuring more anti-nodes per unit length. Alternatively, if the stretch is very open, the RF generator 322 is able to automatically decrease the frequency, thereby decreasing the wavelength and thus decreasing the number of anti-nodes per unit length.

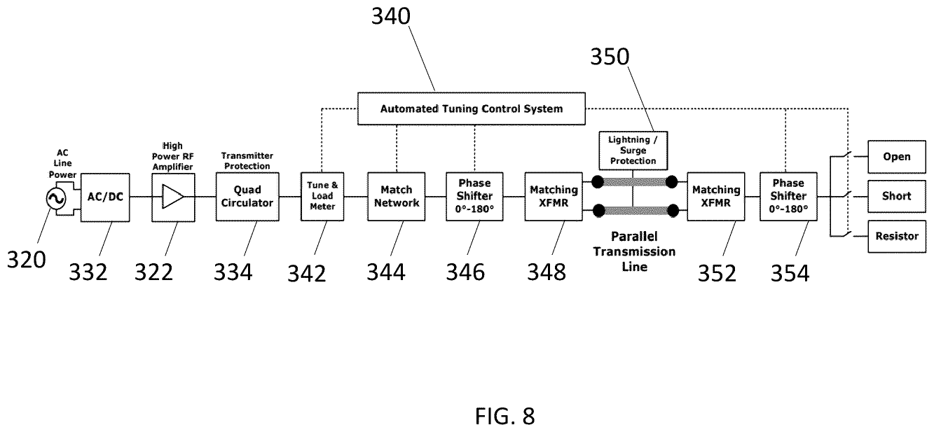

FIG. 8 illustrates a conceptual diagram for a mobile charging system according to one embodiment of the present invention. In one embodiment, the grid power source 320 provides alternating current to the system. In one embodiment, the grid power source 320 is connected to at least one AC-DC rectifier 332. In one embodiment, the grid power is then amplified by at least one RF amplifier 322. In one embodiment, the amplified signal then enters into a quad circulator 334, the use of which helps to isolate elements of the system, such as transmitters, from excess RF energy. The signal is then able to be modified by an automated tuning control system 340. The automated tuning control system 340 includes and/or is connected to at least one tune & load meter 342, at least one match network 344, and/or at least one phase shifter 346, 354. In one embodiment, a combination of a second matching transformer 352 and a phase shifter 354 are used to shift the node/anti-node and/or to match power transfer with a subsequent transmission line segment. In one embodiment, the system operates to minimize or prevent reflection along the transmission lines, but in other embodiments, other levels of reflection are permitted (or even maximized). In one embodiment, the system includes a lightning and/or surge protection system 350 between the parallel transmission lines.

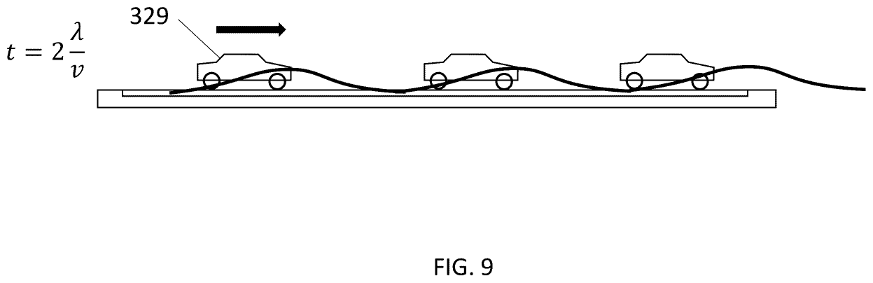

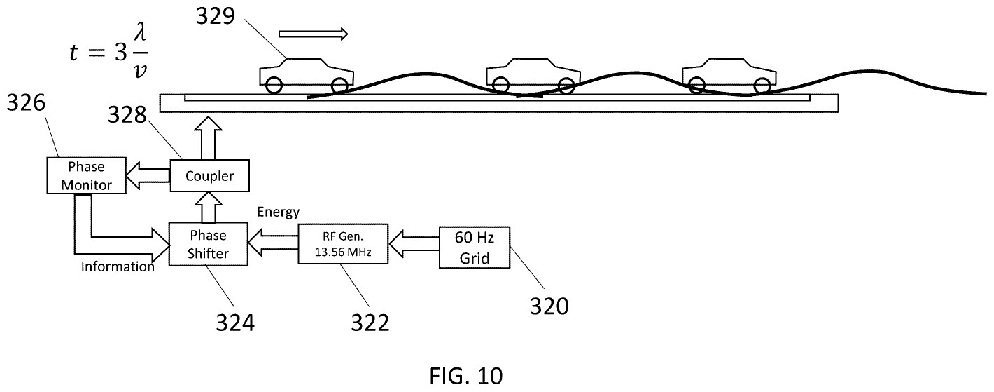

FIGS. 9-10 illustrates mobile charging systems with node velocity faster than vehicle velocity according to one embodiment of the present invention. In one embodiment, the standing waves are configured to move at a faster velocity than the vehicle 329. In one embodiment, the standing waves move at approximately 50 times the average speed of the vehicles 329, 100 times the speed of the vehicles 329, thousands of times the speed of the vehicles, or at any multiples of the speed of the vehicles 329, such that the antinodes of the standing waves pass by the vehicles 329. With sufficient velocity, this system allows the vehicles 329 to be charged without tracking the location of the vehicle, or requiring the vehicles to utilize self-driving mechanisms to align with antinodes produced by the system. As shown in FIG. 10, the circuit elements for each case are substantially similar, with the main difference being in the produced frequency by the RF generator 322. For example, in one embodiment, the RF generator generates a frequency of approximately 13.56 MHz, but one of ordinary skill in the art will understand that this value will change for different wave velocities.

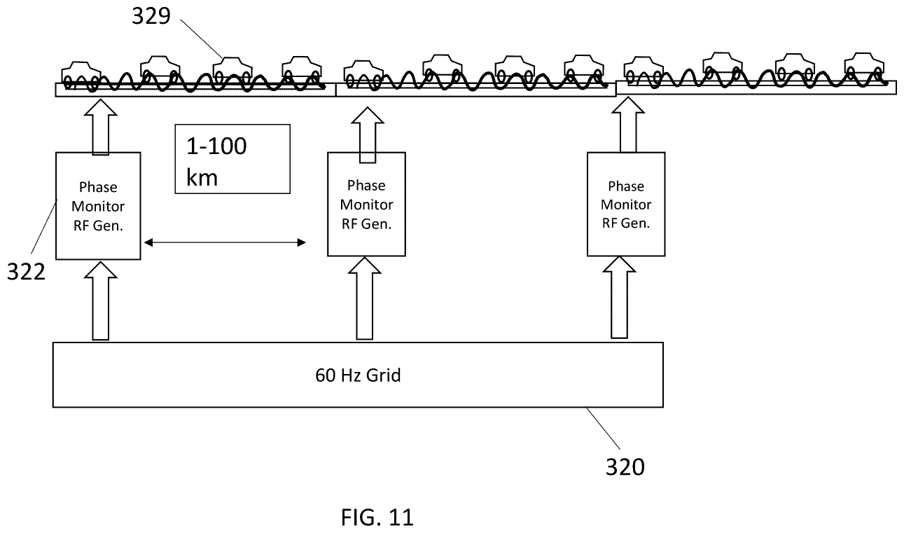

FIG. 11 illustrates a mobile charging system with multiple transmission line segments in series according to one embodiment of the present invention. In one embodiment, a plurality of vehicles 329 travel along a roadway which includes a plurality of transmission line segments each innervated by a separate RF generator 322 and each monitored with at least one phase monitor to match phase between adjacent transmission line segments. In one embodiment, a single power grid source 320 provides power to a plurality of adjacent transmission line segments, while, in another embodiment, one or more of the transmission line segments are powered by different power grid sources. In one embodiment, the RF generators are separated by a distance of approximately 1 to approximately 100 km.

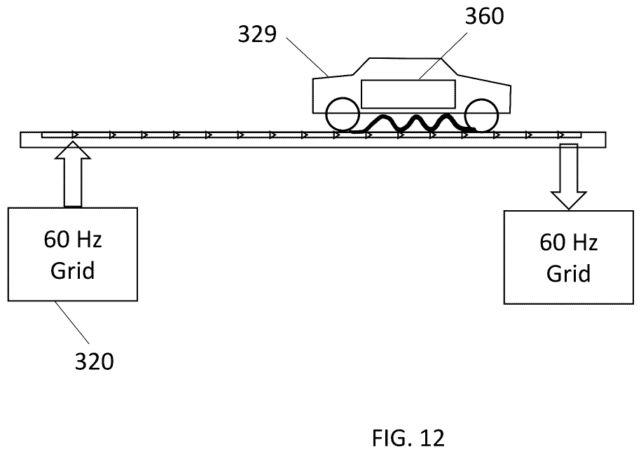

FIG. 12 illustrates a mobile charging system with an on-vehicle RF generator according to one embodiment of the present invention. FIG. 12 represents an alternative paradigm for the present invention compared with the embodiments shown in FIGS. 7-11. In this version, a vehicle 329 includes an on-board RF generator 360 operable to generate an RF signal emitted below the vehicle 329. The road still includes at least one power line operable to receive power from at least one power grid source 320, but does not require an RF generator embedded in the road or to be used at all apart from the one onboard the vehicle 329. In one embodiment, the system does not require the ground system to generate RF power at all and instead allows power to flow into a cable embedded in the road at a first location and to return to the grid at a second end.

The embodiment shown in FIG. 12 is advantageous as the specific physical orientation of the car and the embedded cables causes the RF field to only be generated directly below the vehicle and not to be generated outside of that area. This provides for less wasted energy and reduced RF energy pollution in general, while still allowing for efficient charging of the vehicle on the move.

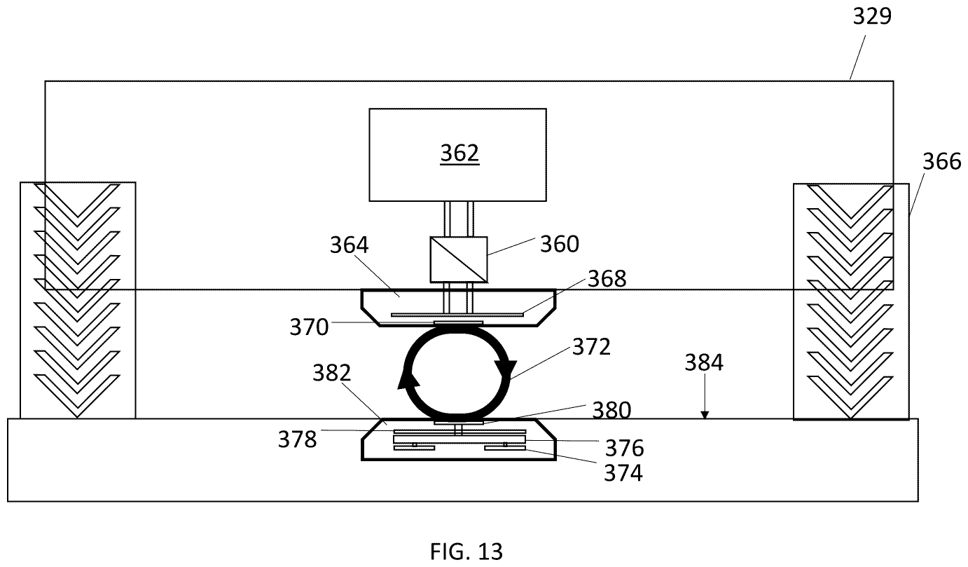

FIG. 13 illustrates a cross-sectional diagram of a mobile charging system with an on-vehicle RF generator with a single cable according to one embodiment of the present invention. In one embodiment, a vehicle 329 includes at least one onboard RF generator 360 operable to generate RF signals directed toward the ground with power supplied by at least one battery 362 of the vehicle 329. The at least one onboard RF generator 360 is positioned between the wheels 366 of the vehicle 329. In one embodiment, the at least one onboard RF generator 360 is positioned above the vehicle mounted receiver 364, which includes a magnetic reflector layer 368 and a wireless power transfer (WPT) coupling layer 370. In one embodiment, the WPT coupling layer 370 is positioned below the magnetic reflector layer 368.

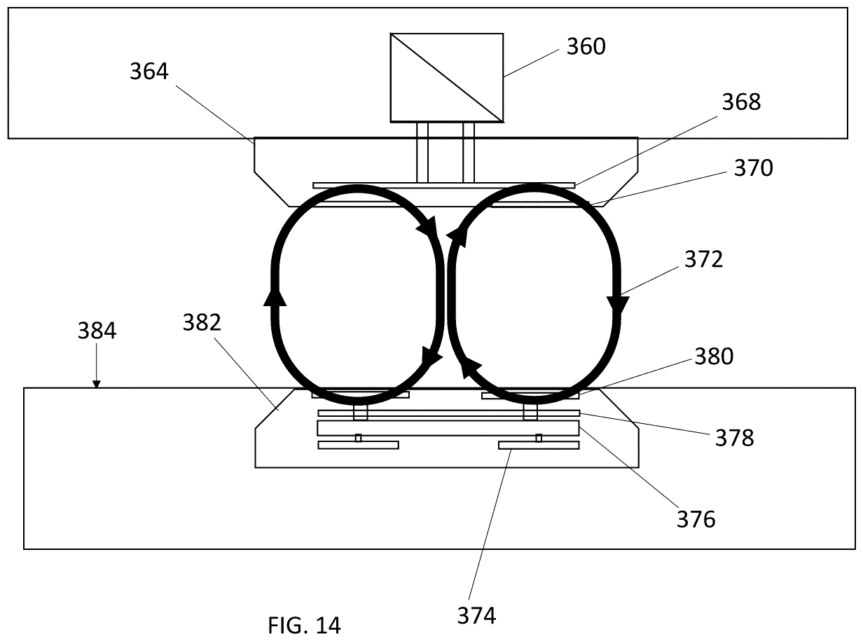

An embedded amplifying wire 382 is embedded within the road surface 384. The embedded amplifying wire 382 includes a WPT coupling layer 380 proximate to the road surface 384. The present invention is compatible with two separate WPT coupling layers 380, as shown in FIG. 14, or with any number of WPT coupling layers 380. Increasing the number of WPT coupling layers 380 tends to increase the efficiency and speed of the charging process. In one embodiment, the number of WPT coupling layers 380 in the embedded amplifying wire 382 is matched by the number of WPT coupling layers 370 in the vehicle mounted receiver 364. Magnetic flux lines 372 form between the WPT coupling layers 380 in the embedded amplifying wire 382 and the WPT coupling layers 370 in the vehicle mounted receiver 364, allowing for charging of the vehicle battery 362 to occur. Due to the high frequencies utilized in this process, large inductor coils are not needed, allowing for less bulky systems to be utilized while still providing charging.

In one embodiment, a magnetic reflector layer 378 is positioned beneath the WPT coupling layer 380. In one embodiment, a distributed amplifier layer 376 is positioned beneath the magnetic reflector layer 378. Finally, one or more grid lines 374 are positioned beneath the distributed amplifier layer 376 and are operable to supply power from a central power grid, one or more microgrids, and/or from one or more distributed energy resources (e.g., one or more solar panels, one or more batteries, one or more geothermal power generators, etc.). In one embodiment, the power supplied by the one or more grid lines 374 is direct current, while in other embodiments, it is supplied as alternating current (e.g., with frequencies of 15 Hz, 60 Hz, etc.).

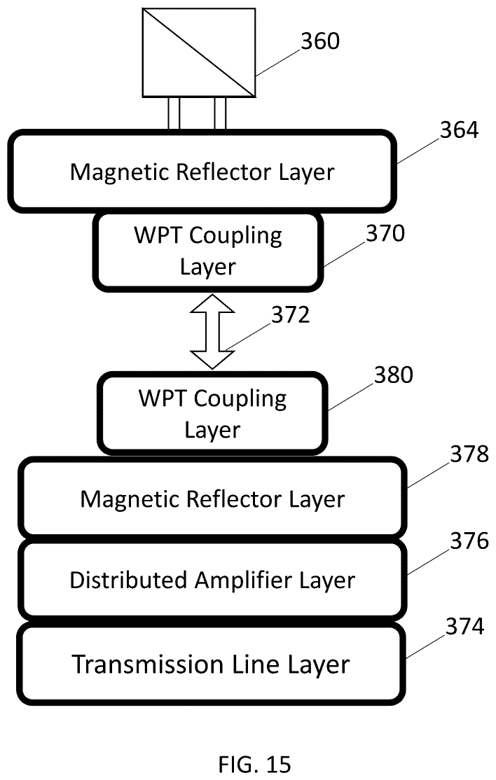

FIG. 15 illustrates a conceptual diagram of components of a mobile charging system with an on-vehicle RF generator according to one embodiment of the present invention. FIG. 15 provides a conceptual diagram showing the relative orientations of the RF generator 360, magnetic reflector layer 368 and WPT coupling layer 370, which form part of the electric vehicle, and the transmission line layer 374, distributed amplifier layer 376, magnetic reflector layer 378, and WPT coupling layer 380, which form part of the ground system. The vehicle and ground system are magnetic coupled by magnetic field lines 372.

In one embodiment, the distributed amplifier layer 376 includes one or more distributed amplifier elements. Amplifier elements are able to include any amplifier known in the art, including those having some combination of diodes, transistors, and/or other circuit elements. Examples of signal amplifier circuits include, but are not limited to, those described in U.S. Pat. Nos. 10,251,127, 8,892,035, and 9,281,711, each of which is incorporated herein by reference in its entirety. Alternatively, the distributed amplifier layer 376 is able to be formed as a large vertical diode, having an n-doped semiconductor layer disposed above or below a p-doped semiconductor layer, allowing the entire layer to act as an amplifying diode. Additionally or alternatively, the amplifier is able to be configured as described, for example, in the article MESFET Distributed Amplifier Design Guidelines by authors Beyer et al., published by IEEE in March 1984, which is incorporated herein by reference in its entirety. Preferably, the distributed amplifier layer demonstrates negative resistance distributed across the road-wire, and allows power signals of, for example, 10 W from the vehicle at about 30-500 MHz to be amplified greatly to, for example, greater than 20 KW (e.g., 2000 times amplification). Exemplary negative resistance layers are shown, for example, in the article Low-Frequency Negative Resistance in Thin Anodic Oxide Films by author Hickmott, published in the Journal of Applied Physics in 1962, which is incorporated herein by reference in its entirety. In one embodiment, the returned, amplified power is not at the same frequency as the power supplied by the electric vehicle (e.g., is at a multiple of the original frequency, or is a combination of discrete frequencies within some bandwidth, etc.), while, in another embodiment, the amplified power is at approximately the same frequency as the powered supplied by the electric vehicle

In one embodiment, the magnetic reflector layer 378 in the ground system and/or the magnetic reflector layer 368 in the electric vehicle are configured as metasurfaces. In one embodiment, one or more of the magnetic reflector layers 368, 378 are configured as frequency-selective surfaces for specific frequencies or frequency ranges utilized in the system, such as the artificial magnetic conductors (AMCs) having specific hole cut patterns described, for example, in the article Design of Planar Artificial Magnetic Conductor Ground Plane Using Frequency-Selective Surfaces for Frequencies Below 1 GHz by authors de Cos et al., published by IEEE in 2009, which is incorporated herein by reference in its entirety. Advantageously, the use of AMCs for frequency-selective surfaces to enable magnetic reflection does not require expensive materials with particular rare properties to be used, as the system is more dependent on the geometry of the layer, rather than the material properties, allowing for a much less expensive system. Other metasurfaces able to be used in the magnetic reflector layers 368, 378 of the present invention include those described in the article Switchable nonlinear metasurfaces for absorbing high power surface waves by authors Kim et al., published in Applied Physics Letters in 2016, which is incorporated herein by reference in its entirety.

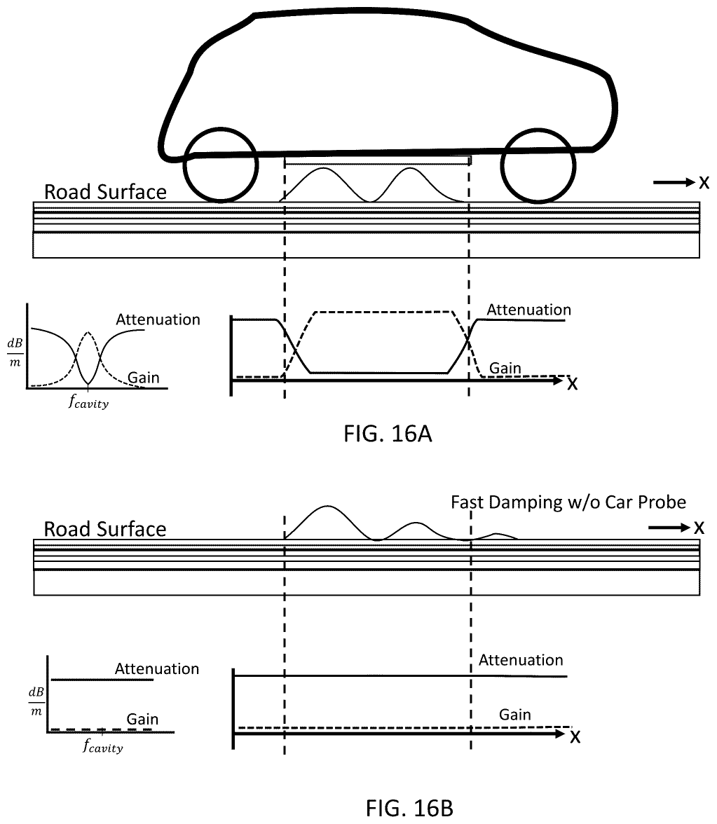

FIGS. 16A and 16B illustrate the state of a mobile charging system reliant on on-vehicle RF generators with and without a vehicle present. FIGS. 16A and 16B show that when a vehicle is driving over the parallel cable transmission line system with an RF generator generating an initial signal, the amplification is able to occur and charge the vehicle. However, when the on-vehicle RF generator is not present, there is no signal being amplified by the parallel line transmission system and thus the energy is low. This allows the system to prevent waste and prevents errant RF signals from propagating except for the intended purpose of charging the vehicle.

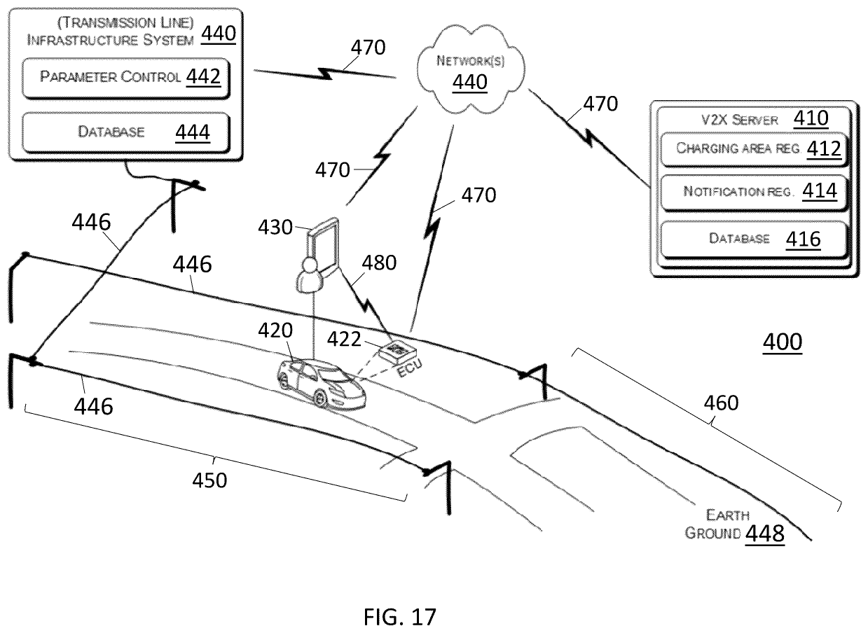

FIG. 17 illustrates a network architecture for a parallel transmission line for wireless power transfer to an electric vehicle (EV) according to one embodiment of the present invention. In one embodiment, the EV power delivery utilizes non-ohmic coupling between a pair of parallel transmission lines and a receiving antenna configured in a particular orientation and located at an offset distance from the parallel transmission lines. In one embodiment, the transmission line includes cables that are parallel and suspended in the air (i.e., an actual pair of parallel cables), or at least one cable suspended in the air and paired with a lossy ground or another underground cable (i.e., a simulated suspended parallel transmission line). In one embodiment, by identifying the presence and configuration of the pair of parallel cables, the receiving antenna of a moving or stationary EV, is configured to receive energy transfers from the pair of parallel cables. In one embodiment, the configuration includes adjustment of alignment or antenna orientation relative to a layout of the transmission line, a geolocation of the EV, an adjustment of antenna resonant frequency, and/or other parameters.

In one embodiment, the network environment 400 is a V2X communication environment that facilitates communications between a V2X server 410 and other V2X components such as an electric vehicle (EV) 420, user equipment (UE) 430, and a transmission line infrastructure system 440. In one embodiment, the EV 420 includes an embedded electronic control unit (ECU) device 422. In one embodiment, the V2X server 410 includes a charging area register 412, a notification register 414, and a database 416. In one embodiment, the infrastructure system 440 includes a transmission line parameter control 442 and a database 444 to operate one or more transmission lines 446. The parameter control 442 is able to configure transmission line terminations, operating frequencies, and/or the operating power of the transmission lines 446. For illustration purposes, the transmission lines 446 are able to represent the actual pair of parallel cables able to transfer energy to the EV 420 along a path length 450, while a transmission line 446 and an earth ground 448 represents a simulated pair of suspended parallel wires able to transfer energy to the EV 420 along a path length 460. The EV 420 is shown to be mobile in this example and receives a wireless power transfer from the pair of transmission lines 446 along the path length 450 at a first instance and along the path length 460 at a second instance.

In one embodiment, the V2X server 410 performs V2X communications with the other V2X components through a radio interface 470, such as, for example, a Long Term Evolution (LTE) interface (Uu) for cellular network communications. In one embodiment, the V2X components also establish and/or perform V2X communications with one another through a direct communication channel interface 480, such as, for example, an LTE V2X interface or new radio (NR) V2X interface (PC5 interface) for direct communications. In one embodiment, the direct communication channel interface utilizes a shared spectrum such as the 5.9 GHz unlicensed band and, in some cases, the V2X communications utilizes both interfaces at the same time.

In one embodiment, the V2X server 410 facilitates a wireless power transfer between the transmission line 446 and the EV 420 via a centralized management of the V2X components in the network environment 400. For example, the V2X server 410 receives information associated with the transmission line 446 and the EV 420 that subscribed to wireless power transfers by the transmission line. The information of the EV 420 includes geolocations, respective battery status, associated antenna configurations, and the like. In one embodiment, the information associated with the transmission line 446 includes their transmission length, layout, operating frequencies, location, type of deployment, whether they are suspended in the air or buried underground, termination, loading, and/or other parameters. In this example, the V2X server 410 utilizes the received information as a reference when sending notifications that include control signal information to the infrastructure system 440 and the EV 420. The control signal information includes a determined configuration of the receiving antenna in the EV 420, information about other charging areas relative to the geolocation of the EV 420, and/or other information. In various embodiments, the EV 420 uses its embedded ECU device to determine the configuration of its receiving antenna.

In one embodiment, transmission lines 446 include coaxial cables, or other systems of conductors able to transfer electrical signals from one location to another location. In one embodiment, the transmission lines 446 include uninsulated electrical cables suspended from towers or insulated electrical cables that are buried underground. These electrical cables are classified based on their operating voltages, transmission line length, and/or other parameters. For example, a Low Voltage (LV) transmission line carries less than 1000 volts and is used to distribute power to residential or small commercial customers. In another example, a short transmission line is shorter than 25 miles long, and so on. In this embodiment, the transmission lines 446 are terminated to generate traveling waves or standing waves able to be used for wireless power transfer to the EV 420 via non-ohmic coupling. The standing waves are generated when the transmission lines include unmatched termination while the traveling waves are produced then the transmission lines are properly terminated (i.e., matched termination). In various embodiments, the information associated with the transmission lines 446 is transmitted by the infrastructure system 440 to the V2X server 410 via networks.

In one embodiment, the infrastructure system 440 includes software, hardware, or a combination thereof, to control the amount of power, operating frequency, termination, nodes, and/or other parameters of the transmission lines 446. The infrastructure system 440 utilizes a parameter control 442 and database 444 to adjust the setting of the transmission lines 446 for purposes of rendering wireless power transfer to another V2X component such as the EV 420. In one embodiment, the transmission lines 446 include at least one cable that is suspended above a ground plane (e.g., suspended in the air) and paired with a lossy ground or paired with another cable that is similarly suspended above the ground plane. In this embodiment, the pairing between the at least one transmission line and the lossy ground such as the earth ground 448 are configured to simulate the pairing between the pair of parallel transmission lines that are above the ground plane or suspended in the air. As shown in FIG. 17, the actual pair of suspended parallel cables 446 extend along the path length 450 while the simulating pair of cable 446 and earth ground 448 extend along the path 460.

In one embodiment, the EV 420 includes an automobile propelled by one or more electric motors, using energy stored in its vehicle battery. Although not strictly EVs, hybrid vehicles are also able to be propelled by one or more electric motors in addition to an internal combustion engine. In one embodiment, the EV 420 includes a unique vehicle identification number (VIN), embedded sensors, navigation applications to identify GPS location, and other applications that are installed in the embedded ECU device of the vehicle. In one embodiment, a vehicle battery (not shown) of the EV includes a rechargeable battery such as a lithium-ion battery. The vehicle battery includes parameters such as maximum operating voltage, minimum operating voltage, maximum self-charge, state-of-charge that defines a total energy of the battery over available energy of the battery, depth of charge, and discharging rates. In one embodiment, one or more of these battery parameters, VIN, and/or other electric vehicle or data information are stored in the embedded ECU device 422 of the EV 420. In one embodiment, subscriber EV 420, via its ECU device 422, continuously uploads its data information to the V2X server 410.

In one embodiment, an embedded ECU device 422 includes a wireless communication electronic device integrated into a vehicle's platform as a portable computing system. The device 422 includes onboard diagnostic (OBD) and telematic compute unit (TCU) that send the EV's data information to the V2X server 410 and/or to another V2X component such as another EV or the infrastructure system 440. In one embodiment, the device 422 includes hardware circuit components able to process data, perform transmission and reception of data through a cellular network connection (cellular network), broadband network, telephonic network, an open network such as the Internet, a private network, the direct communication channel, or any combination thereof. Further, the device 422 is able to be configured to be a subscriber of one or more mobile network operators (MNOs) or wireless telecommunications network service providers (WTNSPs). The subscription is able to be preconfigured during vehicle manufacture and is adjustable from time to time such as, for example, when the device changes MNOs/WTNSPs and/or adds network subscription features. The subscription, for example, facilitates vehicle-to-network (V2N) communications between the device 422 and the V2X server 410 through the networks 440. In one embodiment, the device 422 is configured to be a subscriber of an energy transfer application able to facilitate the wireless power transfer between the V2X components in the V2X communication environment. In this embodiment, the EV 420 uses the energy transfer application to receive the wireless power transfer from the transmission lines 446.

In one embodiment, the V2X server 410 includes general-purpose computers, network servers, or other electronic devices capable of receiving input, processing the input, and generating output data. In one embodiment, the input includes the information associated with the EV 420, the infrastructure system 440, and the transmission lines 446. In one embodiment, the output data includes a determined configuration of the receiving antenna that is associated with the EV 420 for wireless power transfer.

In one embodiment, the UE 430 includes or is embodied by a cellular phone, a smartphone, a session initiation protocol (SIP) phone, a laptop, a personal digital assistant (PDA), a satellite radio, a global positioning system (GPS), a multimedia device, a video device, a camera, a game console, a tablet, a smart device, a wearable device, or any other similar functioning device. The UE 430 is also referred to as a station, a mobile station, a subscriber station or unit, a wireless unit, a mobile device, a wireless device, an access terminal, a handset, a user agent, a mobile client, or some other suitable terminology. In some embodiments, the UE 430 uses the radio interface 470 to establish cellular network communications with other V2X components such as the EV 420 and/or the infrastructure system 440. In one embodiment, the UE 430 also uses the direct communication channel interface 480 to establish and perform V2X communication with the embedded device 422 of the EV 420.

In an example embodiment of the wireless power transfer operation, the V2X server 110 receives data information from the EV 420. In one embodiment, the data information includes the geolocation of the EV 420, EV battery parameters, and/or configuration of a receiving antenna that is associated with the EV 420. Here, for example, the EV 420 is a subscriber to the energy transfer application that is implemented by the V2X server 410 as a subscription provider. During subscription, a user of the EV 420 registers the VIN of the EV 420, name of owner, and other information such as the user device 430 that is associated with the user or owner of the EV 420. In this example, the EV 420 continuously broadcasts its data information to the V2X server 410 via the networks 440. In various embodiments, the infrastructure system 440 also sends layout, location, or configurations of the transmission lines 446 to the V2X server 410 for centralized management of the wireless power transfer between the transmission line 446 and the EV 420.

With the received data information of the EV 420, the V2X server 410 is able to utilize the charging areas register 412 to identify the transmission lines 446 that are located within range of the geolocation of the EV 420. Further, the V2X server 410 is operable to retrieve the layout, one or more parameters, or configurations of the transmission lines 446 from the database 416 and utilize the retrieved configurations to determine the likely configuration of the receiving antenna of the EV 420. In some embodiments, the V2X server 410 uses machine learning algorithms to determine likely settings of the receiving antenna at the geolocation of the EV 420. In these embodiments, a data model is based upon historical data from previous energy transfer operations at the geolocation of the EV 420. The likely settings, for example, include a particular antenna orientation, operating frequency, and/or power. In one embodiment, upon determination of the configuration of the EV receiving antenna, the V2X server 410 sends a notification to the EV 420 and in some cases, to the infrastructure system 440.

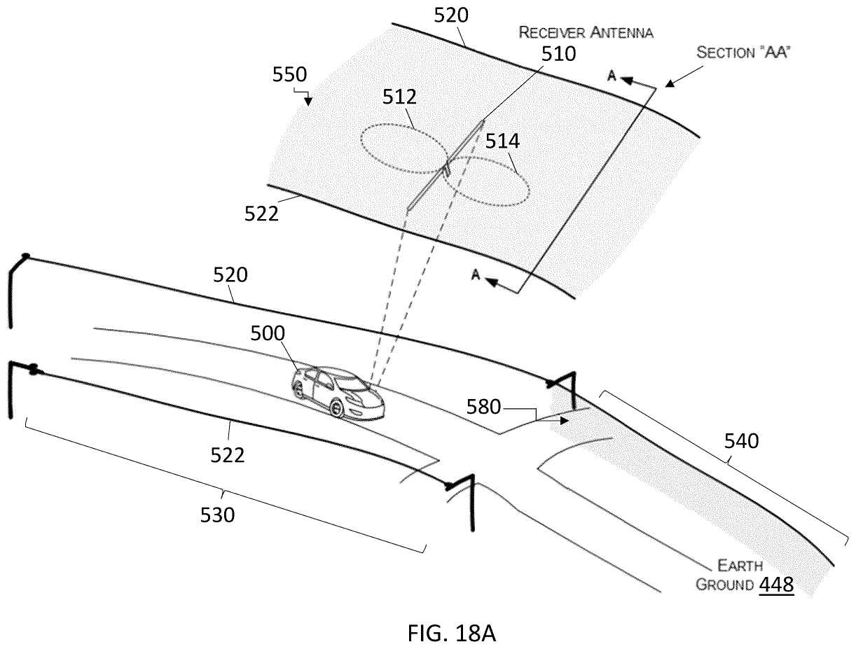

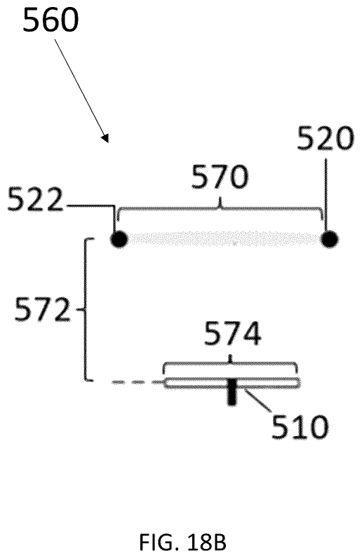

FIG. 18A is a schematic diagram of actual and simulated parallel cables providing wireless power transfer to a receiver antenna of a moving electric vehicle according to one embodiment of the present invention. FIG. 18B is a cross-sectional diagram of the parallel line transmission system shown in FIG. 18A taken along section AA. An EV 500 is included with a receiver antenna 510 able to be used to receive wireless power transfer from transmission lines 520 and 522. The EV 500 and the transmission lines 520 and 522 correspond to the EV 420 and transmission lines 446 of FIG. 17.

In one embodiment, the receiver antenna 510 includes a half-wave dipole antenna with radiation lobes 512, 514 to receive non-ohmic coupling from the pair of parallel cables 520 and 522 along a path length 530, which corresponds to the path length 450 of FIG. 17. In one embodiment, the radiation lobes 512, 514 include radiations patterns that are perpendicular to a conductor of the half-wave dipole antenna. As the EV 500 moves to a path length 540, which corresponds to the path length 460 of FIG. 17, the pairing between the cable 520 and the earth ground 448 simulates the pair of suspended parallel cables 520 and 522 in the previous path length 530. In this embodiment, the EV 500 adjusts the configuration of the receiving antenna 510 as the EV 500 moves from the path length 530 to the path length 540. In both path lengths 530, 540, the receiving antenna 510, via electromagnetic coupling, receives wireless power transfer to charge the battery of the EV 500.

In an example embodiment, when the EV 500 is traversing the path length 530, the receiver antenna 510 is configured to have the radiation lobes 512, 514 aligned in parallel with an imaginary plane 550, which is formed by connecting the parallel cables 520 and 522. As the EV 500 traverses the path length 530, which, in one embodiment, is a highway that is in between the transmission lines 520 and 522, a length of the half-wave dipole receiver antenna 510 is aligned or adjusted to be perpendicular to the length of the parallel transmission lines 520 and 522.

For example, as indicated by section “AA” 560, the EV 500 and thus the receiver antenna 510 is under and in between the cables 520 and 522, which form the imaginary plane 550. A gap 570 indicates a distance between the parallel cables 520, 522 while an offset distance 572 indicates a vertical distance of the receiver antenna 510 from the imaginary plane 550 that is formed by connecting the cables 520, 522. In this example, and as the EV 500 traverses the path length 530, the receiver antenna 510 is configured to have its antenna length 574 to be parallel and perpendicular to the layout or configuration of the cables 520 and 522.

In some embodiments, the offset distance 572 between the receiver antenna 510 and the imaginary plane 550 includes a distance that is at least equal to the gap 570 to receive the wireless power transfer. In this embodiment, the wireless power transfer is performed when the receiver antenna 510 is more or less at an offset distance 572 from the imaginary plane 550, which represents a high electromagnetic field region between the cables 520 and 522 that induces electrical energy to a resonant receiver antenna 510. In some embodiments, the receiver antenna 510 includes multiple half-wave dipole antennas able to toggle to cover multiple orientations. The orientations are based upon layout, location, and configuration of the cables along with the geolocation of the EV 500. In these embodiments, the V2X server 410 uses stored transmission layout, locations, transmission line length, associated path lengths, and other information when determining a desired configuration of the receiver antenna 510.

In some embodiments, as the EV 500 traverses the path length 540, the receiver antenna 510 receives non-ohmic coupling between the pair of the cable 520 and the earth ground 448. For example, the receiver antenna 510 is a half-wave dipole antenna. In this example, the radiation lobes of the half-wave dipole antenna are able to be adjusted to be parallel to an imaginary plane 580 formed by connecting the cable 520 to the earth ground 448. Here, the length 574 of the half-wave dipole antenna is configured to be in an upright direction (i.e., perpendicular to a height of the transmission line 520) and at an offset distance from the imaginary plane 580 formed by connecting the transmission line 520 to the ground. In some embodiments, the V2X server 410 monitors the wireless power transfers at the path length 540. In these embodiments, the V2X server 410 utilizes one or more machine learning algorithms to infer a ranking of the antenna configurations that facilitate the wireless power transfer at the path length 540.

In some embodiments, the receiver antenna 510 includes a combination of different antenna configurations with different operating frequencies. In this example embodiment, the V2X server 410 and/or the embedded device in the EV 500 uses machine learning algorithms to rank the antenna configurations able to be used for the wireless power transfer. For example, the receiver antenna 510 receives a first amount of energy transfer at a first operating frequency, a first geolocation, and as it traverses the path 530 in a first direction. The receiver antenna 510 also receives a second amount of energy transfer at the same operating frequency, geolocation, and as it traverses the path 530 at an opposite direction. In this example, the V2X server 410 or the EV 500 processes the historical data and uses one or more machine learning algorithms to rank the configuration of the receiver antenna 510 as the EV 500 traverses the path 530 in a particular direction.

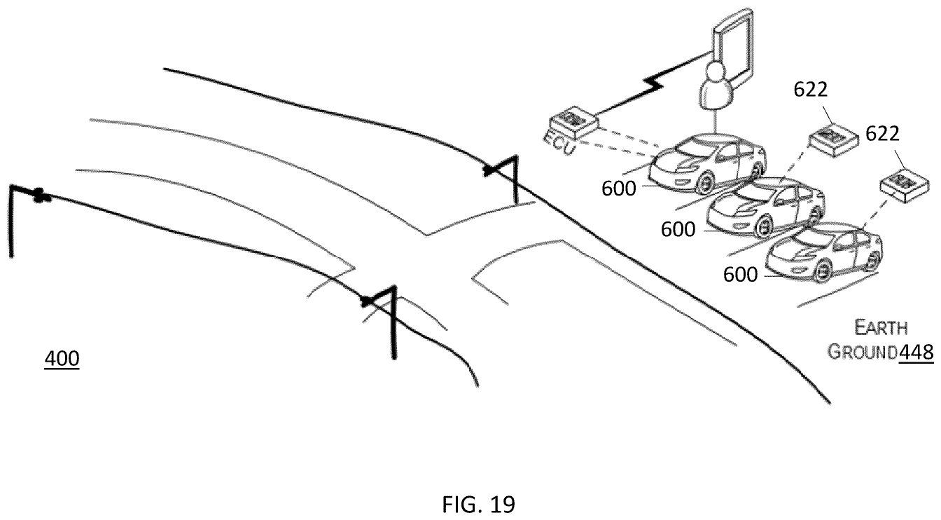

FIG. 19 is a schematic diagram of actual and simulated parallel cables constituting a transmission line providing wireless power transfer to a receiver antenna of a stationary electric vehicle according to one embodiment of the present invention. In this example, a stationary EV 600 with an ECU device 622 is used to receive wireless power transfer from parallel cables.

However, in one embodiment, the system is able to be integrated in a V2X system that involves active communication between the vehicles and the transmission line infrastructure system. For example, in one embodiment, the receiver antenna of the electric vehicle includes multiple half-wave dipole antennas that are able to be toggled into multiple orientations, potentially based on the layout, location, and/or configuration of the cables relative to the electric vehicle. In one embodiment, charging through the transmission line system is entirely initiated and controlled by the V2X server (albeit with the vehicles and vehicle operators having the choice whether to charge or use the line transmission system at all), with the V2X server sending permissions to allow the vehicle to begin charging via the system, commands to reduce amount of charging, commands to cease charging, or permissions to increase the amount of charge. In another embodiment, charging is initiated largely independently by each vehicle, but the V2X server is able to provide parameters to improve charging speed and/or charging efficiency for the vehicle, playing a more supplementary role.

In one embodiment, a V2X server stores the cable layouts, locations, transmission line lengths, associated path length, and/or other information regarding the transmission line infrastructure system. In one embodiment, the V2X server is able to receive a location of one or more electric vehicles. In one embodiment, the V2X server determines one or more preferred orientations of the receiver antennas and transmits one or more suggestions to the electric vehicles given their current location. In one embodiment, the V2X server includes an artificial intelligence module operable to determine a ranking of antenna configurations that will best facilitate wireless power transfer. In one embodiment, the artificial intelligence module takes into account historical data (e.g., from each particular vehicle, from a dataset of similar vehicles, and/or from a dataset of all vehicles) in order to determine the ranking of antenna configurations. In another embodiment, the V2X server is able to transmit data regarding the transmission line infrastructure system to the electric vehicles such that the electric vehicles are able to determine, with onboard processing capabilities, a preferred orientation of the receiver antenna.

In one embodiment, the V2X server includes a charging areas register, a notification register, and a database. In one embodiment, the database stores V2X component identifications, V2X component locations, EV battery parameters, EV receiver antenna configurations, transmission line configurations, historical data for one or more parameters, and/or other information pertaining to the transmission line infrastructure and/or individual electric vehicle parameters. In one embodiment, V2X component identifications includes unique vehicle identification numbers (VINs) associated with each electric vehicle 10., vehicle classifications (e.g., emergency vehicles, private vehicles, public vehicles, etc.), vehicle make, vehicle build, vehicle color, and/or other data associated with specific vehicles. In one embodiment, the V2X component locations include Global Positioning System (GPS) data for the vehicles and/or other indications of the geolocation of the vehicles. In one embodiment, EV battery parameters include maximum and/or minimum operating voltages, maximum self-charge, state-of-charge that indicates a level of charge of the battery relative to its capacity, discharging rates, and/or other parameters. In one embodiment, EV receiver antenna configurations includes the alignment and orientation of one or more antennas, operating frequencies, and/or other parameters associated with one or more antennas on each electric vehicle. In one embodiment, transmission line configurations includes length of the transmission lines between nodes, amount of loading (overall and/or per segment), load matching, power frequency, amount of power, layout or manner of deployments (e.g., suspended in the air or buried underground), gap distance between transmission lines, distances and height (or depth) of transmission lines, and/or other transmission line parameters relating to carrying power from one node to another node. In one embodiment, the V2X server receives data updates regarding vehicle geolocation, battery parameters, receiver configurations, transmission line configurations, and/or other variables and updates and/or adds to the database values accordingly. The V2X server is able to control configurations and properties of the cables, including but not limited to, current and voltage across individual segments of the transmission line system, inductive or resistive coupling between different segments of the transmission line system, and/or other parameters.

In one embodiment, the V2X server is operable to communicate with an onboard processor of each electric vehicle via a Uu interface. One of ordinary skill in the art will understand that the V2X server is not necessarily a single server at a centralized location, but is able to encompass a plurality of servers or server nodes distributed throughout an area (e.g., placed at locations in the vicinity of the transmission line). In one embodiment, this encompasses an edge computing paradigm, wherein servers or server nodes at positions proximate to the transmission lines (or relevant transmission line segments) perform the bulk of the processing, while one or more central servers handles larger scale management and backfill, with a reduced processing load.

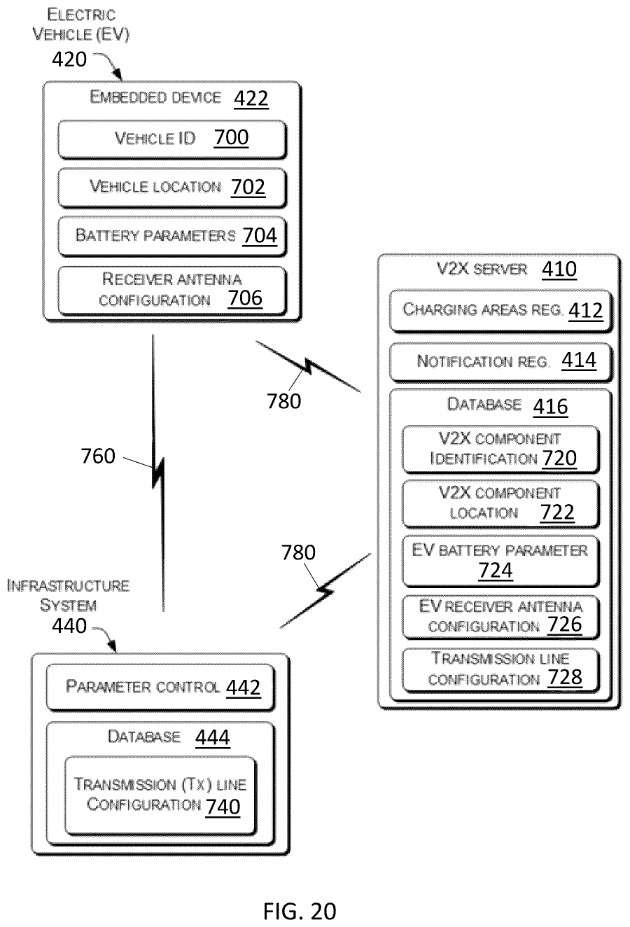

FIG. 20 is a block diagram showing exchange of data information between a vehicle-to-everything (V2X) server and other V2X components in a V2X communication environment according to one embodiment of the present invention. In FIG. 20, the V2X server 410 is able to perform the central management for the wireless power transfer between the transmission lines and the EV 420.

As shown, the EV 420 is represented by the embedded device 422 which further includes a vehicle ID 700, vehicle location 702, battery parameters 704, and receiver antenna configuration 706. In one embodiment, the V2X server 410 includes the charging areas register 412, notification register 414, and the database 416 that further includes a V2X component identification 720, V2X component location 722, EV battery parameter 724, EV receiver antenna configuration 726, and transmission line configuration 748. In one embodiment, the infrastructure 440 includes the parameter control 442 and the database 444, which includes a transmission line configuration 740.

In one embodiment, EV 420 and the infrastructure system 440 exchange data information through a PC5 interface 760 while the V2X server 410 communicates with the embedded device 422 through a Uu 780. For example, the V2X server 410 implements the centralized management for the wireless power transfer by sending control signals to the EV 420 and the infrastructure system 440 via the Uu 780. The control signals include desired antenna configuration of the EV 420. In another example, the EV 420 directly communicates with the infrastructure system 440 via the PC5 interface 760 for the purposes of receiving energy transfer. In this other example, the infrastructure system 440 is located along the vicinity of the transmission lines where the EV 420 is geolocated.

In one embodiment, the vehicle ID 700 stores information such as a unique vehicle identification number (VIN) that is associated with the EV 440. The vehicle ID 700 also includes the vehicle classification (e.g., emergency vehicle, private vehicle, public vehicle), make, build, and/or color. During subscription, the V2X server 410 receives the data in the vehicle ID 700 and stores the received data in the V2X component identification 720. In various embodiments, the V2X component identification 720 stores the vehicle IDs of the different subscriber EVs in the network communication environment.

In one embodiment, the vehicle location 702 stores information such as a current location of the EV 420. The EV 420 uses a Global Positioning System (GPS) or other navigation mechanisms to detect its current physical location. Particularly, the EV 420 is able to use its GPS and/or installed geolocation tracking application (e.g., Google map) to track its location at different portions of a projected path when traversing a road towards a destination point. In an example embodiment, the V2X server 410 receives updates in the geolocation of the EV 420 and stores the geolocation updates in the V2X component location 722. In various embodiments, the V2X component location 722 stores the updated geolocations of the different subscriber EVs in the network communication environment. Here, the V2X server 410 uses the V2X component identification 720 to identify the corresponding geolocations of the different subscriber EVs.

In one embodiment, battery parameters 704 include maximum and minimum operating voltages, maximum self-charge, the state-of-charge that indicates a level of charge of the battery relative to its capacity, and discharging rates. These parameters are able to be configured to maintain, for example, a target state-of-charge level that corresponds to an amount of energy that, at any given moment, indicates how much energy is needed to complete a task. In one embodiment, the V2X server 410 receives the data information from the battery parameters 704 and store the data information in the EV battery parameter 724. In various embodiments, the EV battery parameter 724 stores the battery parameters of the different subscriber EVs in the network communication environment.

In one embodiment, receiver antenna configuration 706 include a configuration of the receiving antenna of the EV 420. In one embodiment, the EV 420 includes a half-wave dipole antenna configured to receive the energy transfer from the pair of parallel cables. For example, the EV 420 and thus, the embedded half-wave dipole antenna is located in between the transmission lines. In this example, the half-wave dipole antenna is aligned and configured to receive the wireless power transfer from the transmission lines. The configuration includes an adjustment in orientation, operating frequency, termination, and/or other parameters. In various embodiments, the V2X server 410 receives the updated antenna configuration of EV 420 and stores the antenna configuration in the EV receiver antenna configuration 726. Here, the EV receiver antenna configuration 726 stores the receiver antenna configurations of the different subscriber EVs in the network communication environment.

Referencing the infrastructure system 440, the transmission line configuration 740 includes settings of the different transmission lines that are being operated by the infrastructure system 440. The settings include a length of the transmission lines between nodes, amount of loading, load matching, power frequency, amount of power, layout or manner of deployments such as suspended in the air or buried underground, amount of gap between the transmission lines, distances and height of the suspended transmission lines, and/or other transmission line parameters that relate to carrying of power from one node to another node. In various embodiments, the V2X server 410 receives the parameters of the transmission line configuration 740 and stores the updated transmission line configuration in the transmission line configuration 728. Here, the transmission line configuration 728 stores the transmission line configurations of different transmission line-infrastructure systems in the network communication environment.

In one embodiment, the V2X server 410 monitors and receives data updates from the vehicle geolocation 402, battery parameters 404, receiver configuration 406, parameter control 144, and/or the transmission line configuration 440. The V2X server 410 performs the monitoring continuously, after an interval of time, or upon a detection of a triggering event such as, without limitation, receiving a request for an energy transfer by the EV 420. In this embodiment, the V2X server 410 uses the received data updates to implement the wireless power transfer between the pair of parallel transmission lines and the receiver antenna of the EV 420.

In various embodiments, the V2X server 410 employs one or more trained machine-learning algorithms to infer a list or set of receiver antenna configurations that are likely to correspond with optimal energy transfer between the transmission lines and the EV 420. In one embodiment, the V2X server 410 further analyzes the set of receiver antenna configurations to infer an ordered ranking of the receiver antenna configurations. A superior ranking is able to be afforded to the antenna configuration that is most likely to support the optimal energy transfer to the receiver antenna. For example, the V2X server 410 generates a data model (or predictive model) using historical receiver antenna configurations associated with historical instances of energy transfers between the actual or simulated parallel transmission lines and one or more EVs on a particular geolocation. In this example, the V2X server 410 utilizes the data model on updated data information to rank the receiver antenna configurations that are likely to generate the optimal energy transfer.

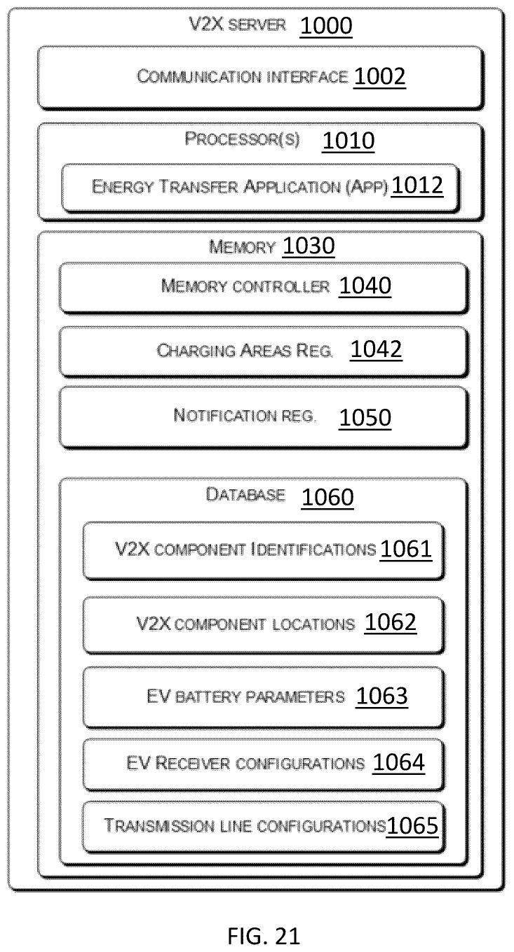

FIG. 21 is a block diagram showing various components of a V2X server according to one embodiment of the present invention. The V2X server 1000 is able to facilitate the wireless power transfer between the pair of parallel transmission lines and a mobile or stationary EV. The V2X server 1000 corresponds to the V2X server 410 of FIG. 17, and described herein to operate with more or fewer of the components as shown.

V2X server 1000 includes a communication interface 1002, one or more processors 1010, and a memory 1030. In one embodiment, the processors 1010 further include an energy transfer application 1012. The memory 1030 further includes a memory controller 1040, notification registers 1050, a database 1060 including V2X component identifications 1061, V2X component locations 1062, EV battery parameters 1063, EV receiver configurations 1064, and transmission line configurations 1065. The notification registers 1050 and database 1060 correspond to the notification register 414 and the database 416, respectively, of FIG. 17.

The communication interface 1002 includes hardware, software, or a combination of hardware and software that transmits and/or receives data from the V2X components such as the EV via its embedded device, UE, and the transmission line infrastructure system. Communication interface 1002 includes a transceiver that facilitates wired or wireless communications through a cellular network or the broadband network. For example, the communications are able to be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a wide area network (WAN), a Wireless wide area network (WWAN), or any broadband network, and further enabled with technologies such as, by way of example, Global System for Mobile Communications (GSM), Personal Communications Service (PCS), Bluetooth, WiFi, Fixed Wireless Data, 2G, 5G (new radio), 3G (e.g., WCDMA/UMTS based 3G networks), 4G, IMT-Advanced, pre-4G, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, HSPA+, UMTS-TDD, 1×RTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks, broadband networks, or messaging protocols.

In one embodiment, the processor(s) 1010 include a central processing unit(s) (CPU), graphics processing unit(s) (GPU), both a CPU and GPU or any other sort of processing unit(s). Each of the one or more processor(s) 1010 are able to include numerous arithmetic logic units (ALUs) that perform arithmetic and logical operations as well as one or more control units (CUs) that extract instructions and stored content from processor cache memory, and then execute these instructions by calling on the ALUs, as necessary during program execution. The one or more processor(s) 1010 are also responsible for executing all computer applications stored in the memory, which are associated with common types of volatile (RAM) and/or non-volatile (ROM) memory. For example, the processor(s) 1010 process data that the V2X server 1000 receives through the communication interface 1002. In another example, the processor(s) 1010 use the communication interface 1002 to send the notifications to the V2X components.

In one embodiment, the energy transfer application 1012 includes hardware, software, or a combination of hardware and software that implements the desired wireless power transfer between the actual or simulated pair of parallel transmission lines and the EV batteries. As described above in FIGS. 8A and 8B, the actual pair of parallel transmission lines are illustrated by the transmission lines 520, 522 along the path length 530 while the simulated pair of parallel suspended transmission lines may be illustrated by the transmission line 520 and the earth ground 448 along the path length 540.

The memory 1030 is able to be implemented using computer-readable media, such as computer-readable storage media. Computer-readable media includes, at least, two types of computer-readable media, namely computer-readable storage media and communications media. Computer-readable storage media includes, but is not limited to, Random Access Memory (RAM), Dynamic Random Access Memory (DRAM), Read-Only Memory (ROM), Electrically Erasable Programmable Read-Only Memory (EEPROM), flash memory or other memory technology, Compact Disc-Read-Only Memory (CD-ROM), digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. As defined herein, computer-readable storage media do not consist of and are not formed exclusively by, modulated data signals, such as a carrier wave. In contrast, communication media embody computer-readable instructions, data structures, program modules, or other data in a modulated data signal, such as a carrier wave, or other transmission mechanisms. The memory 1030 also includes a firewall. In some embodiments, the firewall is implemented as a hardware in the V2X server 1000.

In one embodiment, the memory controller 1040 includes hardware, software, or a combination thereof, that enables the memory 1030 to interact with the communication interface 1002, processor(s) 1010, and other components of the V2X server 1000. For example, the memory controller 1040 facilitates the retrieval of data from the V2X component identifications 1061, V2X component locations 1062, EV battery parameters 1063, and so on, for processing by the processor(s) 1010. Similarly, memory controller 1040 facilitates the storing of the data information from the other V2X components within the V2X communications environment.

Notification register 1050 includes hardware, software, or a combination of hardware and software that stores the notifications that were transmitted to the subscriber V2X components. In one example, the transmitted notifications include the projected charging areas along the path of the EV, subscription charges for the received energy transfer, suggested antenna configurations of the EV along different paths, and the like.

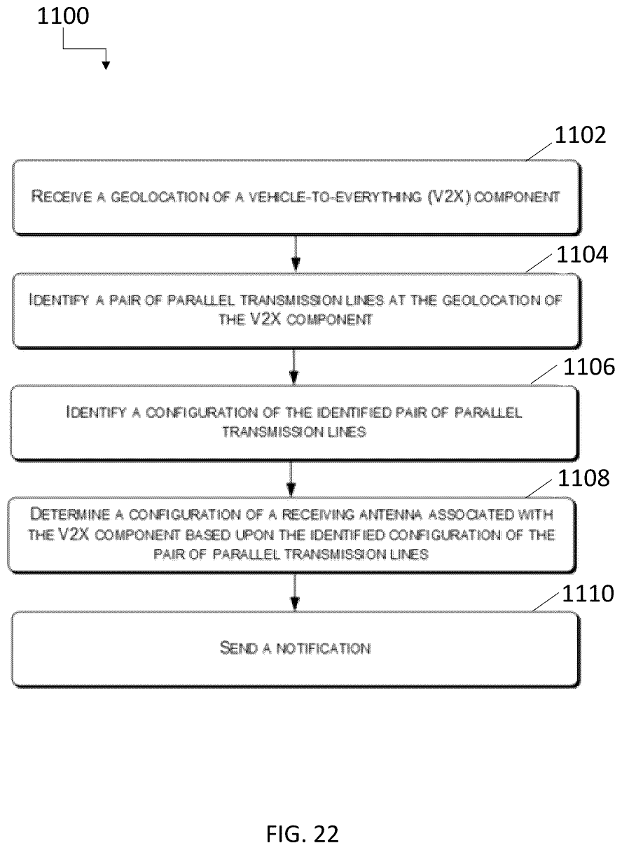

FIG. 22 is a flow diagram of a process for implementing wireless power transfer to an electric vehicle according to one embodiment of the present invention. The process 1100 is illustrated as a collection of blocks in a logical flow chart, which represents a sequence of operations able to be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks are able to be combined in any order and/or in parallel to implement the process. For discussion purposes, the process 1100 is described with reference to FIGS. 7-11.

At block 1102, the V2X server receives a geolocation of a V2X component. In one example, the V2X component includes the EV that continuously transmits its geolocation and other data information to the V2X server. The EV is associated with a receiver antenna.

At block 1104, the V2X server may identifies a pair of parallel transmission lines at the geolocation of the V2X component. In one example, the V2X server uses data information from the infrastructure system that operates the transmission lines. The data information includes locations and configurations of the transmission lines. Here, the V2X server maps the received geolocation of the V2X component to the stored geolocations of the transmission lines and identifies the pair of parallel transmission lines that are able to perform the wireless power transfer to the EV. In various embodiments, the identified pair of parallel transmission lines may include an actual pair or a simulated pair of parallel transmission lines that are within range from the EV. For example, the EV is geolocated between the pair of parallel transmission lines and the receiver antenna is disposed at an offset distance from an imaginary plane that is formed by the pair of parallel transmission lines. In this example, the offset distance is at least equal to a spacing/gap between the pair of parallel transmission lines.

At block 1106, the V2X server identifies a configuration of the identified pair of parallel transmission lines. For example, the configuration includes the layout or type of deployment such as whether the identified pair of parallel transmission lines are suspended in the air, one transmission line is suspended in the air while the paired transmission line that is buried underground, or a single transmission line is suspended in the air and the single transmission line is paired with the earth ground. In this example, the transmission line that is paired with an underground transmission line or the earth ground simulates the pair of parallel transmission lines that are suspended in the air. In another example, the configuration of the pair of parallel transmission lines includes transmission length, operating frequency, and type of termination. The type of termination generates the standing waves or the travelling waves.

At block 1108, the V2X server determines a configuration of a receiving antenna associated with the V2X component based on the identified configuration of the pair of parallel transmission lines. For example, as described in FIGS. 8A and 8B, the EV includes a half-wave dipole antenna. In this example, the determined configuration includes aligning the length of the half-wave dipole antenna to be perpendicular with the pair of parallel transmission lines. In this example still, the radiation lobes that are generated by the half-wave dipole antenna are parallel to the imaginary plane that is formed by connecting the transmission lines.

In another embodiment, the V2X server uses one or more machine learning algorithms to infer a set of configurations for the antenna to receive the energy transfer at the geolocation of the V2X component. In this embodiment, the V2X component initially utilizes a selected configuration from the set of configurations and uses a threshold value to adjust to another configuration in the set of configurations.

At block 1110, the V2X server sends a notification to the V2X component. For example, the notification includes the determined antenna configuration such as, without limitation, an operating frequency, the orientation of the antenna, termination of the antenna, activation of the antenna when traversing a particular path, adjustment of the power of the antenna when traversing a path associated with a simulated pair of parallel transmission lines, and/or other configuration settings.

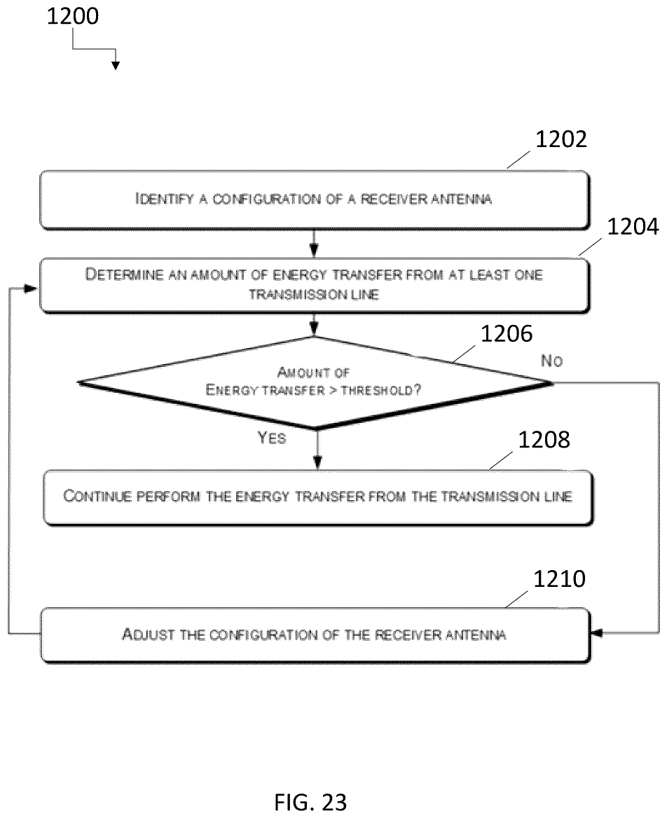

FIG. 23 is a flow diagram of a process for adjusting the configuration of a receiver antenna of an electric vehicle according to one embodiment of the present invention. The pair of parallel transmission lines are able to include actual or simulated pair of parallel transmission lines. The process 1200 is illustrated as a collection of blocks in a logical flow chart, which represents a sequence of operations that are implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks are able to be combined in any order and/or in parallel to implement the process. For discussion purposes, the process 1200 is described with reference to FIGS. 7-11.

At block 1202, the V2X server identifies a configuration of a receiver antenna that is associated with a V2X component. For example, the V2X component includes the EVthat is associated with the receiver antenna.

At block 1204, the V2X server determines an amount of energy transfer from at least one transmission line. For example, the EV continuously transmits data information updates to the V2X server. In this example, the V2X server utilizes the received data information to determine the amount of energy transfer from the at least one transmission line. In various embodiments, the at least one transmission line is paired with another transmission line or paired with the earth ground. In these embodiments, the receiver antenna is geolocated in between the pair of parallel transmission lines.

At decision block 1206, the V2X server compares the received amount of energy transfer with a threshold. If the received amount of energy transfer is greater than the threshold (“Yes” at block 1206), then, at block 1208, the V2X server sends a control signal to the V2X component to continuously perform the energy transfer. However, if the received amount of energy transfer is less than the threshold (“No” at block 1206), then, at block 1210, the V2X server adjusts the configuration of the receiver antenna. The adjustment of configuration, for example, includes changing orientation, operating frequency, or power of the receiving antenna.

After the adjustment of the antenna configuration, and at block 1204, the V2X server continues to determine the amount of energy transfer from the at least one transmission line. In some embodiments, the V2X server utilizes one or more machine learning algorithms to determine the optimal adjustment in the configuration of the receiving antenna.

### Results

Cables with various parameters were tested to determine the power transferred for particular efficiencies, with the assumed coil efficiency being 90% and the assumed current being constant at 1000 A. Tests were performed that evaluated the power transfer, P_{L} and necessary load resistance, R_{L}, needed to achieve the 90% efficiency. The first case, results of which are shown in Table I below, utilized a driving frequency of 20 kHz and a coil number of 250, which demonstrated a power dissipation in 1 km of cable as being approximately 0.817 MW. The second case, results of which are shown in Table II below, utilized a driving frequency of 2 MHz, but with a coil number of 2.5, which showed a power dissipation per 1 km of cable as being approximately 8.17 MW.

TABLE I
20 kHz with N = 250 Results

| a_{c} [mm] | P_{L} [kW] | R_{L} [Ω] |
|---|---|---|
| 0.5 | 2.01 | 79.2 |
| 1.0 | 4.03 | 39.6 |
| 2.0 | 8.06 | 19.8 |

TABLE II
2 MHz with N = 2.5 Results

| a_{c} [mm] | P_{L} [kW] | R_{L} [Ω] |
|---|---|---|
| 0.5 | 20.1 | 7.92 |
| 1.0 | 40.3 | 3.96 |
| 2.0 | 80.6 | 1.98 |

Next, tests were performed measuring the performance of the system with multiple cars, with the number of cars per km, M, varying. It was assumed that Nₕ=10 for each side of the highway, with each cable therefore carrying I/10 A. The current is adjusted so that the power for the load for each vehicle was approximately 3-4 kW at each frequency. A 90% efficiency was assumed for the receiver coil, as in the first tests. Again, tests were performed at 20 kHz and 2 MHz, with the 20 kHz version having 1000 A total (or 100 A per cable) with P_{L} equal to 4.03 kW, and the 2 MHz version having 200 A total (or 20 A per cable) with P_{L} equal to 3.23 kW. For the 20 kHz, a receive coil wire radius of 1 mm with 250 turns was used, while the 2 MHz test utilized a receive coil radius of 2 mm with 2.5 turns. The results of the 20 kHz and 2 MHz multiple vehicle tests are shown below in Tables III and IV, respectively. For the 20 kHz test, power dissipated in 1 km was found to be 81.7 kW, while the number stood at 32.6 kW for the 2 MHz test.

TABLE III
20 kHz with N = 250 Results, multiple vehicles

| M (cars/km) | e_{system} |
|---|---|
| 1 | 4.7% |
| 10 | 33.1% |
| 100 | 83.2% |
| 500 | 96.1% |

TABLE IV
2 MHz with N = 2.5 Results, multiple vehicles

| M (cars/km) | e_{system} |
|---|---|
| 1 | 9.0% |
| 10 | 49.7% |
| 100 | 90.8% |
| 500 | 98.0% |

The tests demonstrate that it is possible to wirelessly transfer sufficient power to a vehicle to charge it while it is driving at high speeds along a highway utilizing cables running along the outside of the highway. Using more cables allows for lower cable loss for the same total current and therefore provides improved power transfer. High efficiencies were demonstrate with approximately 100 vehicles at least being on the road, with higher frequencies (such as 2 MHz) being more efficient than lower frequencies, but with lower load resistances.

One of ordinary skill in the art will understand that although the present invention is primarily intended for terrestrial vehicles traveling along a road, the possibility of suspended cables for use in the present invention, as shown in FIG. 17, allows the present invention to also be used for the purpose of charging aerial vehicles, especially drones or other unmanned aerial vehicles. The method of operation of the present invention for use in drone charging is substantially similar to that used for terrestrial vehicles. One of ordinary skill in the art will understand that terrestrial vehicles includes not only cars and trucks intended for personal use, but also is especially useful for commercial and industrial vehicles, such as semitrucks, forklifts, tractors, and/or other types of vehicles.

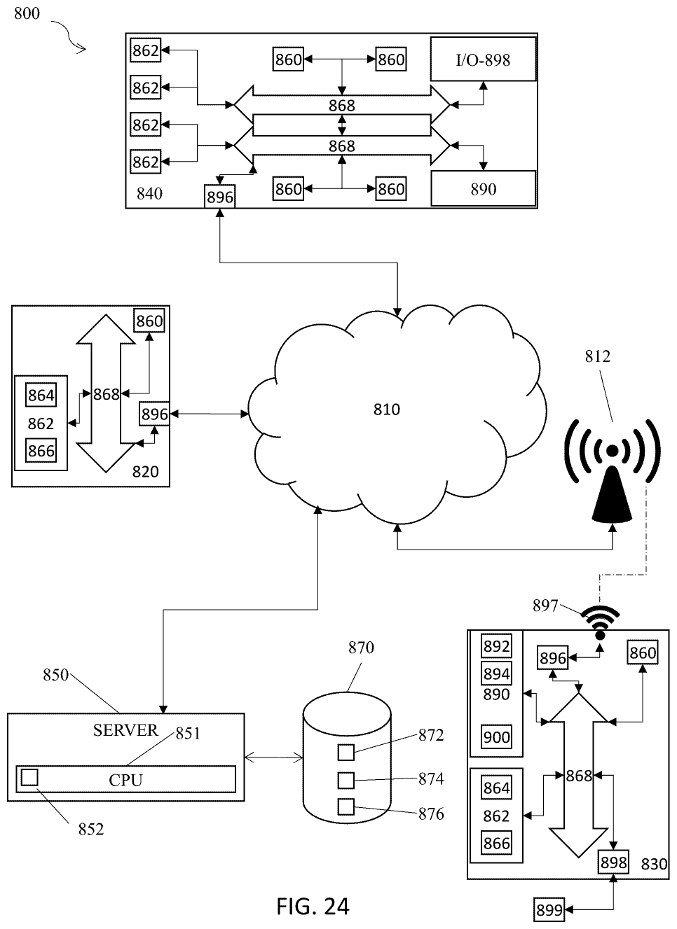

FIG. 24 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 24, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 24, is operable to include other components that are not explicitly shown in FIG. 24, or is operable to utilize an architecture completely different than that shown in FIG. 24. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A mobile charging system for vehicles, comprising:
a plurality of transmission line segments, each including a plurality of parallel cables, within, placed atop, and/or suspended above at least one roadway;
at least one power supply line configured to provide current from at least one power source to the plurality of transmission line segments;
at least one controller configured to modulate an amount of power supplied to the plurality of transmission line segments via the at least one power supply line; and
at least one sensor configured to produce sensor data corresponding to an electromagnetic environment around the plurality of transmission line segments and/or an electric property of the plurality of transmission line segments;
wherein at least one section of the plurality of transmission line segments is oriented substantially parallel with the direction of traffic of the at least one roadway; and
wherein the at least one controller increases or decreases the amount of power supplied to the plurality of transmission line segments via the at least one power supply line based on the sensor data.

2. The system of claim 1, wherein the at least one sensor includes at least one voltage sensor, at least one magnetic field sensor, at least one electric field sensor, at least one line frequency sensor, and/or at least one current sensor.

3. The system of claim 1, wherein the at least one controller is configured to maintain a power level of approximately 1 MW or higher in the plurality of transmission line segments.

4. The system of claim 1, wherein each of the plurality of transmission line segments are formed by at least two concentric cable loops, and where the at least one controller is configured to selectively couple the at least two concentric cable loops of at least two adjacent transmission line segments.

5. The system of claim 4, wherein the selective coupling of the at least two concentric cable loops of the at least two transmission line segments includes inductive coupling and/or direct coupling of the at least two transmission line segments.

6. The system of claim 1, wherein each of the plurality of transmission line segments are formed by at least two concentric cable loops, wherein first sections of the at least two concentric cable loops are substantially parallel and separated by a first gap in or on a first roadway and wherein second sections of the at least two concentric cable loops are substantially parallel and separated by a second gap in or on a second roadway.

7. The system of claim 1, wherein the at least one controller is operable to receive power supply information from at least one power supply source connected with the plurality of transmission line segments, and wherein the at least one controller is operable to transmit a power supply request to at least one central controller.

8. The system of claim 1, wherein the at least one controller is operable to determine a number of electric vehicles on one or more of the plurality of transmission line segments based on the sensor data.

9. A mobile charging system for vehicles, comprising:
a plurality of transmission line segments embedded within, placed atop, and/or suspended above at least one roadway;
at least one power supply line configured to provide current from at least one power source to the plurality of transmission line segments;
at least one controller configured to modulate an amount of power supplied to the at least one cable loop via the at least one power supply line; and
at least one sensor configured to produce sensor data corresponding to an electromagnetic environment around the plurality of transmission line segments and/or an electric property of the plurality of transmission line segments;
wherein at least one section of the plurality of transmission line segments is oriented substantially parallel with the direction of traffic of the at least one roadway; and
wherein the at least one controller is operable to determine a number of vehicles on one or more of the plurality of transmission line segments based on the sensor data.

10. The system of claim 9, wherein the at least one sensor includes at least one voltage sensor, at least one magnetic field sensor, at least one electric field sensor, at least one line frequency sensor, and/or at least one current sensor.

11. The system of claim 9, wherein the at least one controller is configured to maintain a power level of approximately 1 MW or higher in the plurality of transmission line segments.

12. The system of claim 9, wherein each of the plurality of transmission line segments are formed by at least two concentric cable loops, and where the at least one controller is configured to selectively couple the at least two concentric cable loops of at least two adjacent transmission line segments.

13. The system of claim 12, wherein the selective coupling of the at least two adjacent transmission line segments includes inductive coupling and/or direct coupling of the at least two adjacent transmission line segments.

14. The system of claim 9, wherein each of the plurality of transmission line segments are formed by at least two concentric cable loops, wherein first sections of the at least two concentric cable loops are substantially parallel and separated by a first gap in or on a first roadway and wherein second sections of the at least two concentric cable loops are substantially parallel and separated by a second gap in or on a second roadway.

15. The system of claim 9, wherein the at least one controller is operable to receive power supply information from at least one power supply source connected with the plurality of transmission line segments, and wherein the at least one controller is operable to transmit a power supply request to at least one central controller.

16. A mobile charging system for vehicles, comprising:
a plurality of parallel oriented cables constituting at least one transmission line, within, placed atop, and/or suspended above at least one roadway;
at least one power supply line configured to provide current from at least one power source to the at least one transmission line;
at least one controller configured to modulate an amount of power supplied to at least one transmission line via the at least one power supply line; and
at least one phase shifter configured to modulate the phase of power supplied to the at least one transmission line;
wherein activation of the at least one transmission line generates a standing wave of radiofrequency (RF) energy; and
wherein the at least one phase shifter is operable to control movement of nodes and antinodes of the standing wave of RF energy.

17. The system of claim 16, wherein the power supplied to the at least one transmission line has a frequency of at least 1 MHz.

18. The system of claim 16, wherein the vehicles are configured to automatically track and follow the antinodes of the standing wave.

19. The system of claim 16, wherein the at least one controller is operable to receive power supply information from at least one power supply source connected with the at least one transmission line, and wherein the at least one controller is operable to transmit a power supply request to at least one central controller.

20. The system of claim 16, wherein the at least one controller is operable to determine a number of vehicles on the at least one transmission line.
